(19) United States
(12) Patent Application Publication
(10) Pub. No.: US 2020/0094618 A1
(43) Pub. Date: Mar. 26, 2020

(54) STEEL CLIMBING ROBOT WITH MAGNETIC WHEELS

(71) Applicant: Board of Regents of the Nevada System of Higher Education, on Behalf of the University of Nevada, Reno, NV (US)

(72) Inventor: Hung La, Reno, NV (US)

(73) Assignee: Board of Regents of the Nevada System of Higher Education, on Behalf of the University of Nevada,, Reno, NV (US)

(21) Appl. No.: 16/464,874

(22) PCT Filed: Nov. 13, 2017
(86) PCT No.: PCT/US2017/061387

§ 371 Date: May 29, 2019

Related U.S. Application Data
(60) Provisional application No. 62/427,734, filed on Nov. 29, 2016.

(51) Int. Cl. B60B 19/00; G01C 21/00; G01N 21/88

(52) U.S. Cl. CPC B60B 19/006; B33Y 80/00; G01N 21/8851; G01C 21/005

(57) ABSTRACT

Magnetic wheels, steel-climbing robots, and methods and systems for inspection of steel structures are disclosed, along with variations, alternatives, and modifications. A disclosed magnetic wheel has radially oriented rare-earth magnets disposed in an elastomeric wheel body. The magnets are disposed in circumferential rings about the wheel's axis. Neighboring rings have azimuthally staggered patterns. A steel-climbing robot employing such magnetic wheels is capable of traversing steel structures including obstacles, discontinuities, 90° joints, and rough surfaces.

### CROSS REFERENCE TO RELATED APPLICATIONS

This application claims benefit of U.S. Provisional Patent Application No. 62/427,734, filed Nov. 29, 2016, which is incorporated in its entirety herein by reference.

### ACKNOWLEDGMENT OF GOVERNMENT SUPPORT

This invention was made with government support under grant IIP-1559942 and IIP-1535716 awarded by the National Science Foundation. The government has certain rights in the invention.

### FIELD

This disclosure relates to magnetic traction for wheeled vehicles such as robots.

### BACKGROUND

There are currently more than six hundred thousand bridges in the U.S., and many of them are steel bridges. Currently, bridge inspections are mainly performed by inspectors, which requires a significant amount of human resources along with expensive and specialized equipment. Moreover, it is difficult and dangerous for inspectors to inspect large bridges with high structures.

The number of infrastructures, especially bridges, is growing and has recently passed 600,000 in the U.S. Among those, there are more than 200,000 bridges that are either deficient or functionally obsolete and which are likely a growing threat to human safety. The collapse of numerous bridges recorded over past 15 years has shown significant impact on the safety of travelers. In particular, the Minneapolis I-35W Bridge in Minnesota, U.S. collapsed in 2007 due to undersized gusset plates, increased concrete surfacing load, and weight of construction supplies/equipment. There was a recent report in 2013 related to Scott City roadway in Missouri, U.S. collapsing two sections of the bridge onto the rail line. This accident, along with others, has spurred a demand for frequent and adequate bridge inspection and maintenance. However, current activities require great amount of human effort along with expensive and specialized equipment. Besides, most bridge inspections are manually performed by inspectors with visual inspection or using hammer tapping and chain dragging for delamination and corrosion detection, which are very time consuming. Moreover, it is difficult and dangerous for the inspectors to climb up or hang on cables inspecting large bridges with high structures. In addition, reports from visual inspection can vary among inspectors, hence the bridge's condition cannot be assessed precisely.

Therefore, there is a need for advanced technology including robotics to climb bridges and collect data for condition assessment, to safely provide consistent, efficient, and accurate bridge condition reports, to improve the inspection efficiency, and to enhance the safety of inspectors by eliminating dangerous working conditions.

### SUMMARY

In summary, the detailed description is directed to various technologies for magnetic wheels, steel-climbing robots using magnetic wheels, and methods and systems for inspection of steel structures using a climbing robot. An exemplary robot consists of four magnetic wheels which create adhesion to steel surface. It is capable of carry multiple sensors for navigation and mapping. Collected data can be stored in an on-board computer and/or sent to a ground station for real-time monitoring and processing. In addition, magnetic field and range sensors can also integrated to enable the robot to move safely on steel surfaces. Results from both laboratory tests and field tests are shown to validate the feasibility of robot design.

According to one aspect of the innovations described herein, a magnetic wheel is disclosed having rare-earth magnets disposed in an elastomeric wheel body.

In a second aspect, a steel-climbing robot is disclosed employing magnetic wheels and capable of traversing steel structures including obstacles, discontinuities, 90° joints, and rough surfaces.

In a third aspect, a method of using a steel-climbing robot for inspection of a bridge or other steel structure is disclosed.

In a fourth aspect, a system for inspection of a bridge or other steel structure is disclosed, comprising a steel-climbing robot and a ground station coupled by a wireless link. Example systems are also disclosed in which one robot serves as a wireless relay to another robot to enable access to remote interior spaces having poor wireless connectivity.

In a fifth aspect, a method of manufacturing a magnetic wheel is disclosed.

Variations, alternatives, and modifications of these aspects are disclosed.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-B are diagrams depicting a magnetic wheel.

FIG. 2 is a diagram of a magnet.

FIG. 3 is a flowchart of a method of manufacturing a magnetic wheel.

FIG. 4 is a block diagram of a climbing robot.

FIG. 5 is a flowchart of an inspection method using a climbing robot.

FIG. 6 is a block diagram of an inspection system.

FIGS. 7A-B are images of bridge inspectors performing bridge inspections in dangerous settings.

FIG. 8 is a block diagram illustrating the interconnected subsystems of an exemplary steel bridge inspecting robot.

FIG. 9 is a poster illustration of the front and back sides of a steel climbing robotic system with integrated sensors.

FIG. 10 is a block diagram depicting the architecture of a climbing robot.

FIG. 11A is a computer-generated perspective view of a steel climbing bridge robot's three-dimensional design.

FIG. 11B is an image of a prototype of a robot corresponding to the design of FIG. 11A.

FIG. 12 is an illustration depicting the placement Hall Effect sensors on a robot, shown in two different computer-generated views.

FIG. 13 is an illustration depicting the placement of cylindrical magnets in the wheels of a robot.

FIG. 14 is an image of a robot depicting two wheel-lifting shaft mechanisms.

FIGS. 15A-C illustrate the generation of pull forces by different groups of magnets on a wheel.

FIG. 16 is a graph illustrating the relationship between pull force (N) of a single magnet cylinder on the y-axis and the air gap (mm) between the magnetic cylinder and a steel surface on the x-axis.

FIGS. 17A-B are front and side elevation drawings of a robot (dimensions in millimeters).

FIGS. 18A-B are schematic diagrams illustrating scenarios for sliding failure and turn-over failure of a robot.

FIGS. 19A-B are schematic diagrams illustrating forces on robots positioned on the top and bottom of an inclined surface respectively.

FIG. 20 is a schematic diagram illustrating the moment calculation around point A when the robot moves on a vertically inclined surface.

FIGS. 21A-C are schematic diagrams respectively illustrating the geometry of a curved surface including X- and Y-directions, a side view depicting a robot positioned to move along the X-direction, and a front (or rear) view depicting a robot positioned to move along the Y-direction.

FIG. 22 is an annotated diagram of a wheel on a curved surface in an orientation similar to FIG. 21C.

FIG. 23 is a graph illustrating the relationship between pull force (N) of a magnet on the y-axis and the air gap (mm) between the magnet and a steel surface on the x-axis, for a magnet near a curved steel surface similar to FIG. 22.

FIG. 24 is a graph illustrating the relationship between pull force (N) of a wheel on the y-axis and radius of curvature of a steel surface (mm) on the x-axis, for a robot wheel in a configuration similar to FIG. 22.

FIG. 25 is a block diagram depicting a velocity control subsystem for a single wheel.

FIG. 26 is a block diagram depicting a velocity control subsystem for a robot.

FIG. 27 is a pictorial flowchart illustrating a sequence of operations for a robot's edge avoidance process.

FIG. 28 is a geometry diagram illustrating bicycle path planning for a robot.

FIG. 29 is a hybrid diagram illustrating an experimental setup for magnetic force measurement.

FIG. 30 is a graph of magnetic force measurement for a robot on three different supporting surfaces, and three trials each.

FIGS. 31A-E are images depicting a robot adhering to steel surfaces in different situations.

FIGS. 32A-D are images depicting a sequence of positions as an unloaded robot moves along a vertical steel surface.

FIGS. 32E-H are images depicting a sequence of positions as a fully loaded robot moves along a vertical steel surface.

FIGS. 33A-H are a series of images depicting a steel-climbing robot moving up one side of a bridge-like steel structure, and validating an edge avoidance algorithm.

FIGS. 34A-H are a series of images depicting a steel-climbing robot moving up one side of a bridge-like steel structure, and validating an edge avoidance algorithm.

FIGS. 35A-H are a series of images depicting a steel-climbing robot moving up one side of a bridge-like steel structure, and validating an edge avoidance algorithm.

FIG. 36 is a schematic diagram depicting a robot's path along a segmented structure.

FIGS. 37A-D are a series of images depicting a robot traversing a 90° (interior angle) transition.

FIGS. 37E-H are a series of images depicting a robot traversing a 90° (exterior angle) transition.

FIGS. 38A-J are a series of images depicting a robot's motion on a steel surface and validating an edge avoidance algorithm.

FIGS. 39A-D are a series of visual images of a steel structure obtained by a robot's camera.

FIGS. 39E-H are a series of 3-D images of a steel structure obtained by a robot's 3-D imaging camera.

FIGS. 40A-F are a montage of images of a steel-climbing robot performing field tests on various steel structures.

FIGS. 41A-J is a series of individual images obtained by a robot's camera.

FIG. 41K is a stitched image obtained from FIGS. 41A-J.

FIGS. 41L-N are zoom images of three regions indicated on FIG. 41K and illustrating good condition, serious deterioration, and light deterioration respectively.

FIG. 42 is an image of a robot.

FIG. 43 is an image of a robot.

FIG. 44 is an image of a robot showing the locations of some subsystems.

FIG. 45 is an image of a robot showing the locations of some subsystems.

FIGS. 46A-B are images of robots showing the locations of some subsystems.

FIGS. 47A-B are images of an exemplary camera and a time-of-flight sensor.

### DETAILED DESCRIPTION

### I. Introduction

In various embodiments, multi-wheeled robots are provided, which can take advantage of adhesion force created by permanent magnets. As discussed below, such robots can be controlled over a wireless connection and are able to move freely on steel surfaces at various orientations. With an advanced mechanical design, the robot is able to carry a heavy load (approximately 15 pounds) while climbing on both inclined and upside-down surfaces. The robot can also transit from one surface to another surface with up to 90° change in orientation. The robot carries several sensors for visual crack detection and structure mapping. Collected data are stored on-board by a computer in associated storage, and can also be transmitted to a ground station for real-time monitoring and processing. Magnetic field sensors and range sensors can also be integrated to help robot safely traverse steel surfaces. Development of the robot included magnetic force analysis for different surface shapes, and testing in a variety of situations.

### II. Definitions

As used in this disclosure, a wheel is a circular or approximately circular object that rotates about an axis and enables a device to which it is affixed to traverse a surface over which the wheel rolls. A wheel can have a nominally circular shape but can be deformed at a load-bearing point of contact between the wheel and a supporting surface. Wheels have a thickness in an axial direction which can be uniform or non-uniform, and can be larger, smaller, or comparable to a radius of the wheel; a wheel can be a roller. A wheel can be mounted on an axle, but that is not required. Not all rotatable objects of circular cross-section are wheels. For example, motor rotors, Frisbees™, gears, and pulleys are generally not wheels, although each could be adapted in an unconventional way to act as a wheel.

As used in this disclosure, a robot is a programmable machine capable of carrying out a sequence of mechanical actions. Although not required in general usage, the robots of this disclosure are movable and on wheels. Some robots of this disclosure operate via remote control over a wireless link, although these are not requirements. Other robots can be fully autonomous with no base station, or can have wired connections for control and/or power.

As used in this disclosure, a magnet is solid object that generates a magnetic field. A permanent magnet generates a magnetic field in the absence of any electrical circuit providing current. The term magnet excludes objects made of magnetically susceptible materials that can acquire magnetization when in the presence of an external magnetic field and retain a small amount of magnetization when the external magnetic field is removed. Thus, a steel pole piece or a keeper is not a magnet.

As used in this disclosure, steel is a metallic iron-based material having a high (ferromagnetic) magnetic susceptibility, including alloys that are described as “steel” in common usage. A steel object or surface can have a coating, inclusion, or other co-located or proximate material that is not a steel material; if the object or surface is able to grip a common magnet, the object or surface is considered to be a steel object or steel surface, even if the contacting surface is not a steel material.

### III. Exemplary Magnetic Wheels

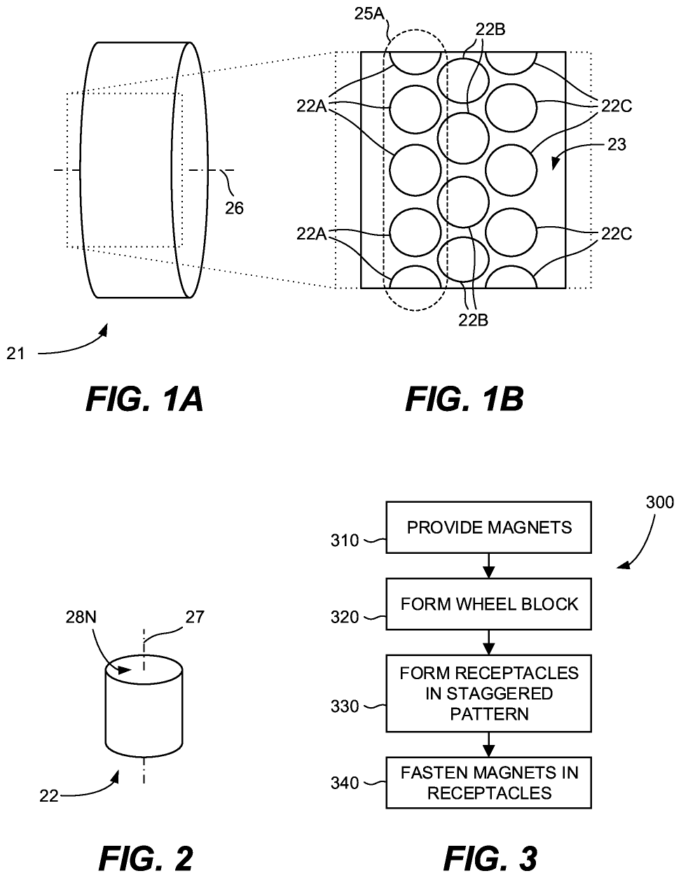

FIGS. 1A-B and FIG. 2 depict a magnetic wheel 21 and its component magnets. FIG. 1A depicts the entire wheel 21, which has an axis of rotation 26. FIG. 1B is an inset, as shown by the dotted lines between FIGS. 1A and 1B. In the inset magnets 22A-22C are embedded or retained in a wheel body 23. Each magnet 22 is disposed in a corresponding receptacle 24 (not marked) of the wheel body 23. The magnets can be flush with the circumferential surface of the wheel body, or they can be recessed, or they can protrude from the wheel body. The magnets 22A are evenly spaced azimuthally in a ring 25A about axis 26A. Likewise, magnets 22B are evenly disposed on a ring 25B (not marked) and magnets 22C are disposed on a ring 25C (not marked). An exemplary magnetic wheel has an axis, and a wheel body in which a plurality of magnets are retained. The magnet patterns of two neighboring rings are staggered in the azimuthal direction. FIG. 2 shows one cylindrical magnet 22 having a magnetic axis 27 collinear with an axis of the cylinder. The magnet 22 has a North pole face 28N as shown, and a South pole face 28S opposite to pole face 28N and hidden in FIG. 2.

In one exemplary magnetic wheel, 36 magnets are arranged in three rings of twelve magnets each, with an azimuthal spacing of 30° between centerlines or magnetic axes of adjacent magnets in each ring. The first ring has magnets at 0°, 30°, 60°, . . . 330° azimuthal angle; the second ring has magnets at 15°, 45°, 75°, . . . 345° azimuthal angle; the third ring has magnets at the same azimuthal positions as the first ring. Thus two adjacent rings (first and second rings, or second and third rings) have magnet patterns that are offset or staggered with respect to each other. Collectively, the patterns of the several rings form one staggered two-dimensional pattern over a circumferential surface of the wheel. Each magnetic wheel has an axis 26 which translates as the wheel rotates about this axis.

In certain examples, the magnets are permanent magnets having magnetic axes oriented in a radial direction of the wheel. This combination of magnet orientation and magnet pattern can advantageously provide an even pulling force between the wheel and a supporting steel surface as the wheel rolls, resulting in lower power requirements for driving motors.

In certain examples, all the magnets of a wheel have the same polarity or orientation, for example all North poles facing outwards, or all South poles facing outwards. Such a magnet arrangement can provide improved pulling force characteristics in situations often encountered where the magnets are not directly in contact with a steel material, as compared with alternating patterns of magnet orientation.

In certain examples, the wheel block is made of a compliant or elastomeric material such as a natural or synthetic rubber. Besides reducing vibration, such wheels can distort at the point of contact with a supporting surface (much like an automobile tire is flattened where it contacts a road), which is advantageous for allowing magnets immediately adjacent to the point of contact to remain in close proximity to a supporting surface for longer as the wheel rolls, thus increasing the pulling force in comparison to a rigid wheel.

In certain examples, the magnetic wheel incorporates no pole pieces or keepers to shape or guide the magnetic field between the permanent magnets of the wheel and the steel supporting surface. Besides being heavy, steel pole pieces are rigid and can be, at least in some embodiments, generally incompatible with a wheel having a compliant wheel body. Thus, incorporating steel pole pieces has its disadvantages, and the absence of pole pieces in some exemplary wheels is an advantage.

### IV. Exemplary Magnetic Wheel Adaptations

Many adaptations of innovative wheels can be implemented within the scope of this disclosure. Magnets can be any ferromagnet or permanent magnet, including iron-nitrogen crystalline magnet materials and rare-earth magnet materials. In certain examples, Neodymium-containing Neodymium-Iron-Boron (NIB) magnets are used, while in other examples, Samarium-containing Samarium-Cobalt or Samarium-Cobalt-Iron-Copper-Zinc magnet materials are used. Magnets can incorporate sintered or bonded magnet material. Magnets can be cylindrical, with circular, square, elliptical, hexagonal, polygonal, or irregular cross-section. Magnets can also be toroidal, or rounded or tapered slugs. Magnet pole faces can be planar, or can be contoured in one or two directions to conform with a circumferential surface shape of a wheel. Magnet surfaces can be smooth, polished, rough, grooved, ridged, or incorporate mechanical fitments. A rough magnet surface can provide better grip in a wheel body. A grooved or ridged surface can mate with corresponding ridges or grooves in a wheel body for stronger retention. Other mechanical fitments such as stubs, screw- or pin-holes, or flanges can support mechanical fastening with or without discrete fasteners. Other approaches to fixing the position of magnets within a wheel body or retainer include the use of adhesive and magnetic force. In addition to rubber and similar compliant materials, the wheel body can incorporate a variety of materials including Aluminum, polymers, and composites, and combinations of materials. Wheels can incorporate a non-skid or abrasive coating for slip-prevention, or a protective coating to reduce wear or corrosion, or provide protection in salt fog environments. The contacting surface of the wheel can be straight in the axial direction, or can be tapered or curved to accommodate special requirements, such as inspection on predictably curved surfaces such as cables, cylindrical structural members, or pipes.

The arrangement pattern of magnets can include any number of circumferential rings, including, for example, 2, 3, 4, 5, 6, 7, 8, 9, 10, 11, 12, or more rings, including 13-20 rings, or 21-100 rings, or up to 1,000 rings. Within a ring, any number of magnets can be used, including, for example, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more magnets, including 31-50, or 51-200, or up to 1,000 magnets. The number of magnets in a wheel can be any number, including the ranges 4-1,000,000, or 6-20,000, or 8-1,000, or 10-360, or 15-120, or 24-72, or 36.

### V. Exemplary Wheel Manufacturing Procedures

FIG. 3 is a flowchart of a method 300 for manufacturing a magnetic wheel. At process block 310, magnets are provided. These magnets may be cylindrical, Neodymium-Iron-Boron permanent magnets, or some other magnets as described above. At process block 320, a wheel block is formed by an additive process or a subtractive process, or a combination of processes, including without limitation one or more of: machining, CNC milling, turning, 3-D printing, casting, molding, grinding, EDM, additive layer manufacturing, laminating, or epitaxy. At process block 330, a plurality of receptacles is formed within the wheel block. The receptacles may be blind holes, clear (through) holes, undersized holes, or over-size holes, and may include features such as protrusions, grooves, ridges, flanges, fastener fitments, or surface roughness to aid in holding magnets in place within the receptacles. As discussed above, it is desirable to have magnets in a staggered pattern. Accordingly, the receptacles are formed in a substantially similar staggered pattern. The receptacles may be formed by drilling or another subtractive process. In some examples, process blocks 320 and 330 are combined to form the wheel block with receptacles in a single process or a single process sequence, for example by 3-D printing. At process block 240, the magnets are fastened within the receptacles to obtain a magnetic wheel having magnets in a substantially similar pattern to the receptacle pattern. The fastening process block may be accomplished by press-fitting, application of adhesive, clamping, mating of mechanical features of the magnets with mechanical features of the receptacles, screwing, or application of discrete fasteners.

Following the manufacture of a wheel by method 300 or a variation thereof, additional process blocks (not shown) can be performed. These include static and/or dynamic balancing of the wheel, and application of a coating. Coatings may be applied by surface application (e.g. painting), immersion, or a spray process, to provide one or more desirable properties such as anti-skid, friction, wear resistance, non-marking, or corrosion resistance. A coating may be selectively applied to magnet pole faces, to other portions of the wheel body, or to any combination thereof.

### VI. First Example Climbing Robot

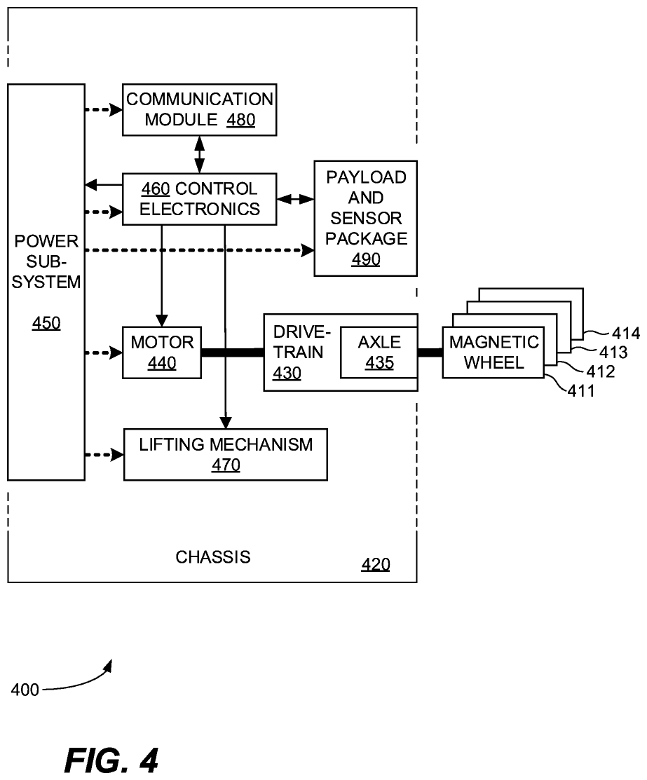

The FIG. 4 is a block diagram of a climbing robot 400, comprising four magnetic wheels 411, 412, 413, and 414, similar to one or more of the magnetic wheels described above. While the climbing robot 400 has four substantially similar wheels, this is not a requirement: other example robots may have a greater or lesser number of magnetic wheels, or may combine magnetic wheels with non-magnetic wheels. At a minimum, robots within the scope of this disclosure have at least one magnetic wheel.

FIG. 4 also shows some other components and subsystems of robot 400. One each of these units is shown for illustration only; one of ordinary skill in the art will recognize that robot 400 can alternatively be provided with two, three, four, or more of any of these units, in any combination, or some of these units can be omitted in certain examples.

Magnetic wheel 411 is mounted on axle 435, which is part of drivetrain 430 coupling motor 440 to the wheel 411. Only one motor and drivetrain are shown for simplicity of illustration; the climbing robot 400 can have independent motors, drivetrains, and axles for each of the wheels 411-414. Independent drive of the magnetic wheels is not a requirement, however: in various examples, two magnetic wheels may share an axle, or a drivetrain, or a motor, in any combination. Particularly, it is not required that any of the magnetic wheels 411-414 be driven: an exemplary robot can incorporate unpowered magnetic wheels, and have powered non-magnetic wheels, or even utilize another drive mechanisms such as a tow rope.

Climbing robot 400 can also include a lifting mechanism 470 to assist in overcoming obstacles such as a lap joint between two steel plates. As described further below, an exemplary lifting mechanism 470 can include a rotatable shaft or cam driven by a separate motor. As the motor turns, the shaft or cam rotates and causes a portion of the robot 400 to lift up, which may result in one or more magnetic wheels detaching from the supporting surface. However, another drive wheel can be used to propel the robot 400 until a position is reached where the lifting mechanism can be de-activated and the raised wheel(s) lowered back to the supporting surface. One of ordinary skill in the art will recognize that the terms raised and lowered as used here and elsewhere are relative to the support surface, so that raised means displaced away from the supporting surface and lowered means displaced towards the supporting surface; the climbing robot 400 is capable of traveling on vertical and underhung surfaces. Example climbing robots 400 can include 0, 1, 2, 4, or more independent lifting mechanisms, which can be associated with respective wheels or with respective sides of climbing robots 400.

Climbing robot 400 also includes control electronics 460, which can incorporate one or more processors and interfaces to other robot systems and components, and can perform low-level and high-level control functions as described further below. Climbing robot 400 also includes a communication module 480, also described further below, and one or more payload and sensor packages 490. Communication module 480 provides a wireless communication link to a ground station (and, in some examples, to one or more other robots) for receiving instruction from an operator or transmitting observational data, analyzed data, navigational data, and/or status information. However, neither the communication module 480 nor any particular communication capabilities are a requirement: in some embodiments, a climbing robot 400 can be fully autonomous, being programmed with a high-level or detailed inspection plan and/or navigation plan, while in other embodiments, communication can be over a wired or optical tether, or by acoustic, infrared, or some other medium.

The climbing robot 400 can incorporate one or more of a substantial variety of sensor types, serving one or more functions including navigation sensing (of position, edges, or obstacles), environmental sensing, internal monitoring (e.g. motor temperature, battery status, or vibration) and inspection. While these are all encompassed within payload and sensor package 490, one of ordinary skill in the art will appreciate that the various sensors may be organized as any combination of discrete devices, subsystems, and combinations thereof, and that one sensor or one sensor package may serve more than one function.

The inspection sensors form at least part of the payload of the robot 400, which in certain examples can also include one or processors, storage, mechanical mounting and housing components, and/or other components.

Climbing robot 400 also includes a power subsystem 450 and a chassis 420. The power unit provides operational power to one or more other subsystems and components of the robot 400, and may include one or more batteries. In certain examples, power subsystem 450 can be organized as one or more connected or independent power units. The chassis 420 supports one or more other subsystems and components of the robot 400, and provides mechanical integrity of the robot 400.

### VII. Exemplary Climbing Robot Adaptations

Many variations and adaptations of climbing robot 400 can be implemented.

Chassis 420 can be implemented as a separate body chassis, an integral chassis, or an articulated chassis, and can incorporate a metal frame, a composite frame, a tubular frame, a graphite structure, a polymer member, or a composite member. In addition to materials such as metal, plastic, and wood, chassis 420 can incorporate one or more materials selected to have a high strength-to-weight ratio, such as a high-entropy alloy, a carbon tube or carbon nanotube material, an ultrahigh molecular weight polyethylene material, carbon fiber composite material, an aramid fiber material, or a polyoxazole material.

Power subsystem 450 can incorporate one or more of an electrochemical battery, a fuel cell, a Lithium polymer battery, a rechargeable battery, a solar cell, or a beamed power receiver. Motors 440 as well as motors included within lifting mechanisms 470 can be of various types, including an AC motor, a brushed DC motor, a brushless DC motor, a geared DC motor, a servo motor, a stepper motor, or a DC linear actuator. Drivetrains 430 can be of various types, such as crab type, holonomic type, swerve type, or tank type, and can incorporate a transmission, a gear transmission, or a flex coupler. Axles 435 can be fixed relative to one or more wheels, or can rotate along with one or more wheels; axles 435 can also be fixed relative to chassis 420 or can incorporate turning, suspension, or lifting capabilities with one, two, or three degrees of freedom, in addition to rotation of the axle 435 about its axis. Lifting mechanism 470 can be of any type; in addition to the motor-driven rotating shaft described elsewhere in this disclosure, lifting mechanism 470 can incorporate a screw mechanism, a hydraulic or pneumatic cylinder, or a linear actuator.

Control electronics 460 can incorporate separate low-level and high-level controllers, or a single controller, or a plurality of controllers for respective subsystems and components of robot 400. FIG. 8 depicts an exemplary distribution of functions between a high-level and a low-level controller. A low-level controller can be configured to perform one or more of: receiving velocity and/or heading commands from the high-level controller; generating PWM control signals for the motors; reading one or more navigation sensors; transmitting navigation sensor data to the high-level controller; analyzing navigation sensor data to determine velocity and/or heading information; or transmitting velocity and/or heading information to the high-level controller. A high-level controller or on-board computer can be configured to perform one or more of: management of the communication subsystem; unidirectional or bidirectional communication between the climbing robot and a ground station; communication with one or more other climbing robots; providing instruction to the low-level controller; receiving data from the low-level controller; controlling the payload package; receiving data from the payload package; analysis of sensor data; fusion of data from navigation sensors, payload sensors, system sensors, and/or advanced sensors; or executing navigation procedures. Control electronics 460 can incorporate a navigation subsystem configured to perform basic point-to-point navigation along a prescribed path, as well as advanced navigation procedures for functions such as edge avoidance, path planning, joint traversal, obstacle negotiation, route planning, linear traversal, areal traversal, or traversal of a structural frame.

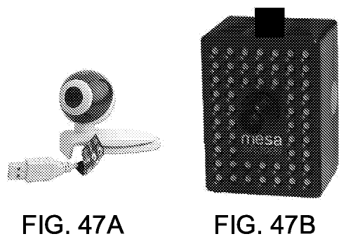

For its various sensing functions, climbing robot 400 can incorporate one or more of: a still camera, a video camera, an acoustic emission sensor, an eddy current sensor, an electrochemical fatigue sensor, an electromagnetic acoustic transducer, a Hall-effect sensor, a fiber-optic sensor, an infrared sensor, a magnetic field sensor, a magneto-inductive sensor, a microwave sensor, a proximity sensor, a range sensor, an RFID sensor, a temperature sensor, a thermographic sensor, a time-of-flight sensor, an ultrasound sensor, or an X-ray sensor. Climbing robot 400 can also incorporate one or more signal stimulus sources associated with any of these sensors, for example an illumination source, magnetic field generating coils, an acoustic source, or an X-ray source. An exemplary camera and a time-of-flight sensor are shown in FIGS. 47A-47B.

### VIII. Exemplary Inspection Methods

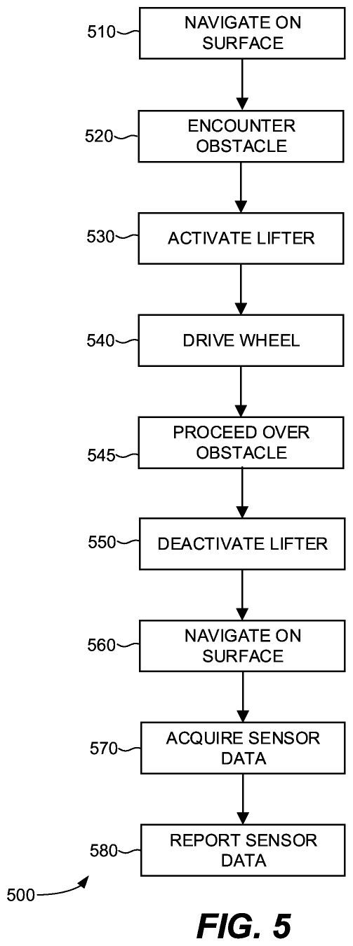

FIG. 5 shows a flowchart 500 for an exemplary inspection method using a climbing robot 400. In this scenario, an obstacle is present en route to a target location on a steel structure being inspected. At process block 510, the robot 400 navigates over a surface of the steel structure. At process block 520, the robot 400 encounters an obstacle. At process block 530, the robot 400 activates a lifting mechanism 470 to raise a portion of the robot 400 in order to have clearance over the obstacle, which may result in raising wheel 410 so that it is not in contact with the surface of the steel structure. At process block 540, the robot 400 controls a motor 440 to power a (different) driving wheel 411 which is still in contact with the steel surface, to propel the robot. Thereby, at process block 545, the robot 400 proceeds over the obstacle. At process block 550, the robot 400 de-activates the previously activated lifting mechanism 470, thereby lowering the previously raised portion of the robot 400 either onto the obstacle, or onto a portion of the surface beyond the obstacle. In certain situations, process blocks 530-550 can be repeated multiple times at a single obstacle, for example to clear a front wheel over the obstacle and then to clear a rear wheel over the obstacle. At process block 560, with the obstacle surmounted or surpassed, the robot 400 continues to navigate towards the target location. Upon reaching the target location, the robot 400 acquires sensor data at process block 570. Associated with process block 570, in certain examples, the robot 400 can also activate stimuli sources required for associated sensors, and can also store the acquired sensor data locally. At process block 580, the sensor data is reported out over a wireless or other communication link.

One of ordinary skill in the art will recognize that many variations of this method are situation-dependent, depending on the details of the inspected structure (including the presence or absence of obstacles, joints, and surface quality variations encountered), the details of the required inspection data, and other factors. The method can be varied dynamically depending on initial sensor data, or obstacles encountered.

Method 500 and its variations are broadly applicable to inspection of a wide variety of steel structures including bridges, ships, storage facilities, pipelines, towers, buildings, or parts or combinations thereof.

### IX. Second Example Climbing Robot

### 1. Overall Design

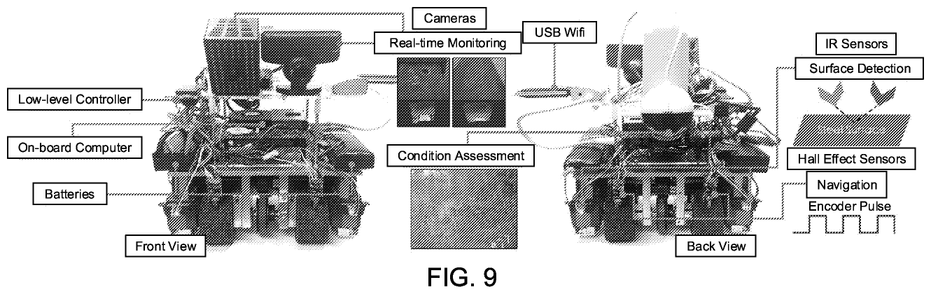

A robotic system with integrated sensors is shown in FIG. 9. A four-motorized-wheels robot is capable of zero-turning-radius maneuver and parallel movement. The robot takes advantage of permanent magnets for adhesion force creation which allows the robot to adhere to steel surfaces without consuming any power. The control hierarchy of the robot consists of two layers: a low-level controller and a high-level controller. The low-level controller handles low-level tasks including converting velocity and heading command from the high-level controller to Pulse Width Modulation (PWM) data to drive motors, and reading data from multiple sensors for navigation purposes. The high-level controller is a more powerful on-board computer for complex processing and communication with a ground station. Various sensor data are fused to provide linear velocity and heading information. Data from advanced sensors provides condition information of a traversed steel structure. The high-level controller sends data to the ground station over a wireless connection for data logging and post-processing.

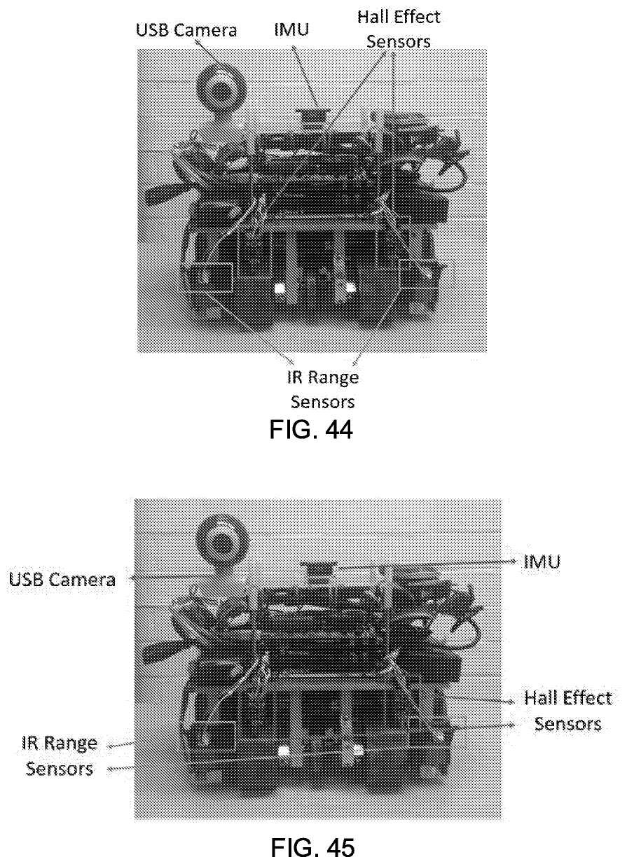

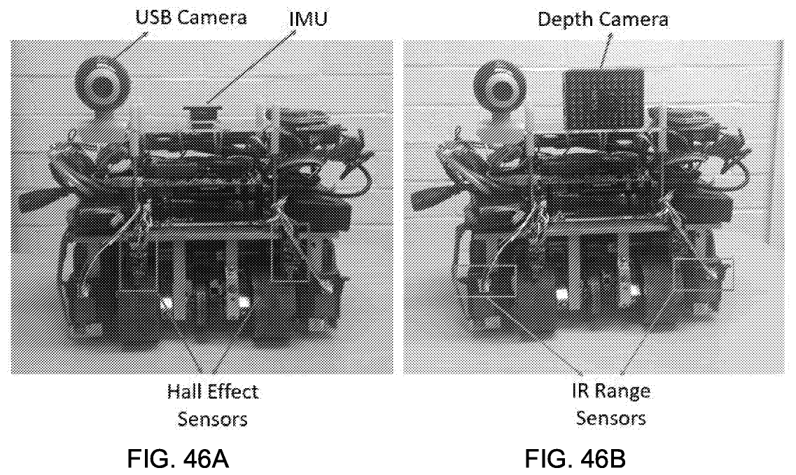

The robot is equipped with various sensors for navigation as well as steel structure evaluation. There are two imaging sensors equipped on the robot: a video camera for visual image capturing and video streaming, and a time-of-flight (ToF) camera from MESA for capturing depth images which can be processed in real-time or subsequently to obtain 3-D maps. Apart from cameras, eight Hall Effect sensors are provided to detect the presence of magnetic fields. FIG. 12 illustrates the sensor mounting for each wheel; two Hall Effect sensors are mounted next to each other and close to each wheel. By taking advantage of the fact that magnet cylinders inside each wheel move when the robot moves, the velocity and traveling distance of each wheel can be determined from the two Hall Effect sensors. An Inertial Measurement Unit (IMU) provides a capability for the robot to determine its own location in space, on the structure. The robot has four infrared (IR) range sensors mounted at four corners of the robot, which can detect the presence or absence of a surface underneath, and assist in detecting edges of a traversed surface. With this information, an edge avoidance algorithm is implemented to ensure the robot's safe travel. FIGS. 44-46 provide some images of sensors mounted on a robot.

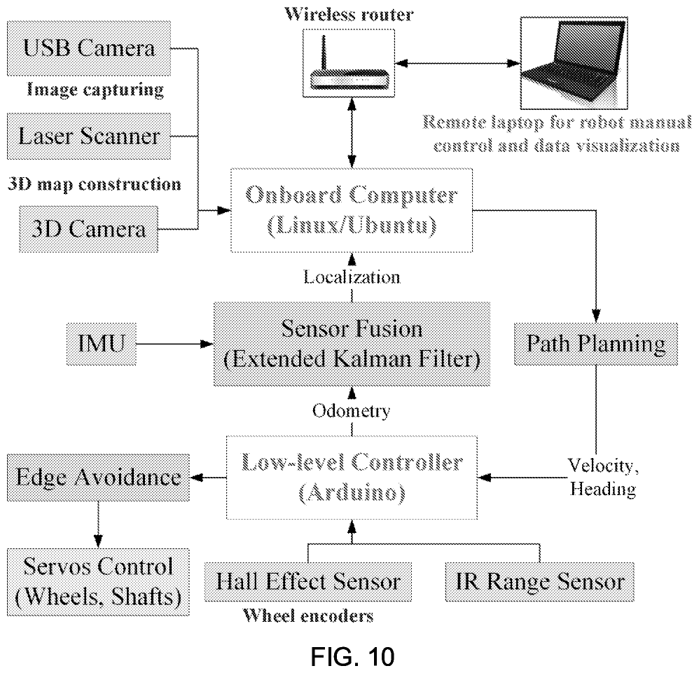

The architecture of the robotic system is shown in FIG. 10. A microcontroller (MCU) based controller is used as the low-level controller, and an industrial on-board computer (from Intel) is used as the high-level controller. The on-board computer runs Robotic Operating System (ROS) for robot localization, navigation, and data collection. The low-level and high-level controllers can communicate with each other using a serial connection protocol. Wireless LAN connection (802.11 or Wi-Fi) is used to transfer collected data from the on-board computer to a remote computer (a ground station) for further processing and also to receive robot control commands from the ground station.

There are several challenges in designing a reliable and robust robot navigation system to safely maneuver on steel structures without falling off the surfaces. Detailed design considerations are further described below.

### 2. Mechanical Design

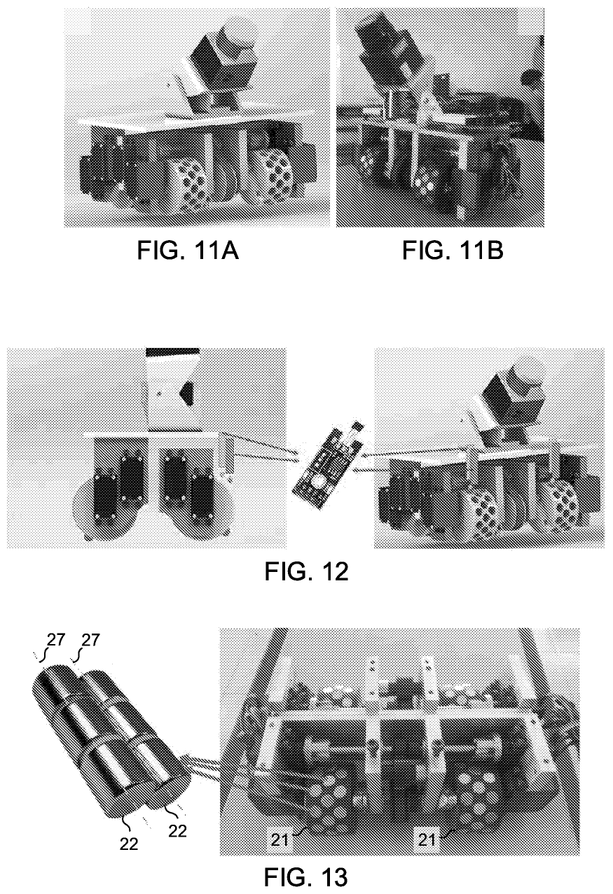

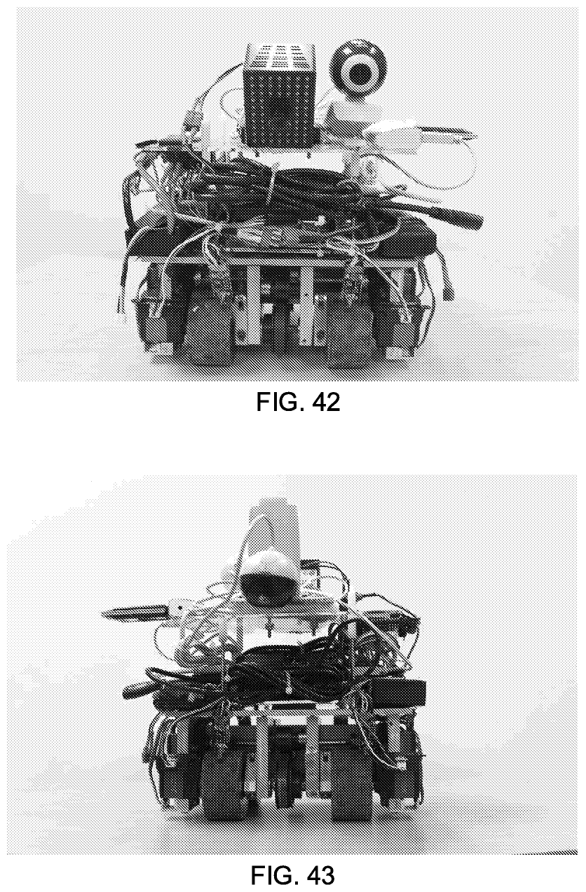

A four-wheel robot design provides maneuvering flexibility. Four motors are used to provide independent drive for the four wheels; another four motors are used to drive the shafts for lifting respective portions of the robot when obstacles are encountered or on rough surfaces. FIGS. 11A-11B depict the 3-D design of the robot and an image of a prototype, respectively, while FIG. 17 provides a CAD drawing, with dimensions in mm. FIGS. 42-43 are additional images of a prototype robot.

The robot's parameters are shown in Table I while the motor's parameters are listed in Table II.

TABLE I
Robot Parameters.

| | | |
|---|---|---|
| Length | 220.9 | mm |
| Width | 130 | mm |
| Height | 241.26 | mm |

| | |
|---|---|
| Weight | 3.5 kg (body only) and 6 kg (full robot) |
| Drive | 4 motorized wheels |

TABLE II
Motor Parameters.

| Torque | 525 g/mm (2S Li—Po) | |
|---|---|---|
| Speed | 0.12 sec/60° (2S Li—Po) | |
| Length | 40.13 | mm |
| Width | 20.83 | mm |
| Height | 39.62 | mm |
| Weight | 71 | g |

| | |
|---|---|
| Voltage | 6-8.5 V (2S Li—Po battery) |

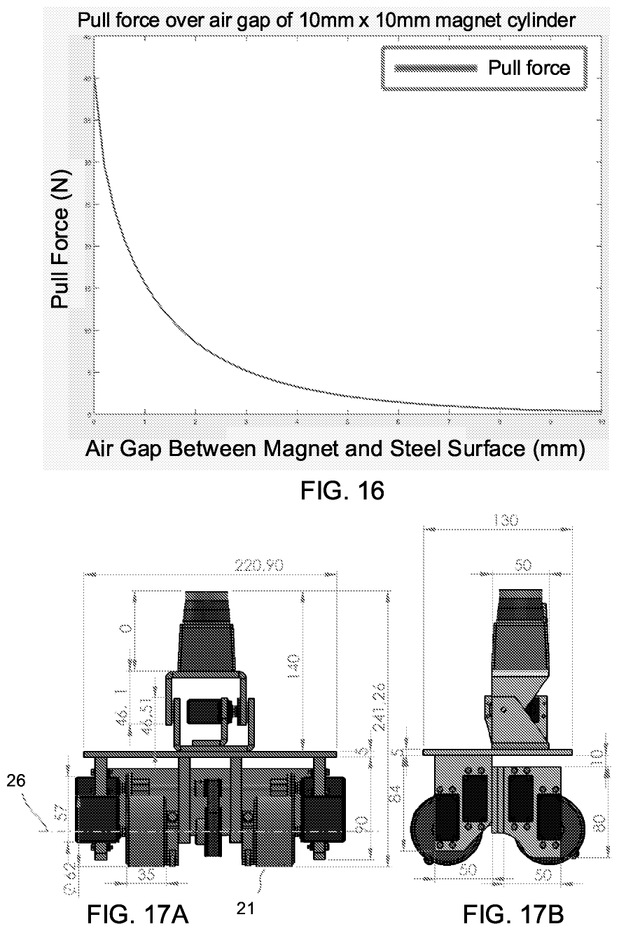

Each wheel contains up to 36 Neodymium magnet cylinders with poles on flat ends as shown in FIG. 13. If there is an air gap between magnet cylinders and steel frame, the pull force is greatly affected. The characteristics of the used magnets (10 mm diameter×10 mm height magnet cylinder) are described in Table III and FIG. 16.

TABLE III
Pull Force (P^{F}) over air gap of 10 mm × 10 mm magnet cylinder.

| | Pull Force P^{F}(Newton N) | | |
|---|---|---|---|
| Distance | Magnet to | Between two | Magnet to |
| (mm) | steel plate | steel plates | magnet |
| 0 | 40.2 | 46.2 | 40.2 |
| 1 | 15.6 | 20.2 | 22.5 |
| 2 | 8.6 | 12.0 | 15.6 |
| 3 | 5.2 | 7.8 | 11.3 |
| 4 | 3.3 | 5.2 | 8.6 |
| 5 | 2.1 | 3.6 | 6.6 |
| 6 | 1.5 | 2.5 | 5.2 |
| 7 | 1.0 | 1.8 | 4.1 |
| 8 | 0.7 | 1.3 | 3.3 |
| 9 | 0.5 | 1.0 | 2.6 |
| 10 | 0.4 | 0.7 | 2.1 |

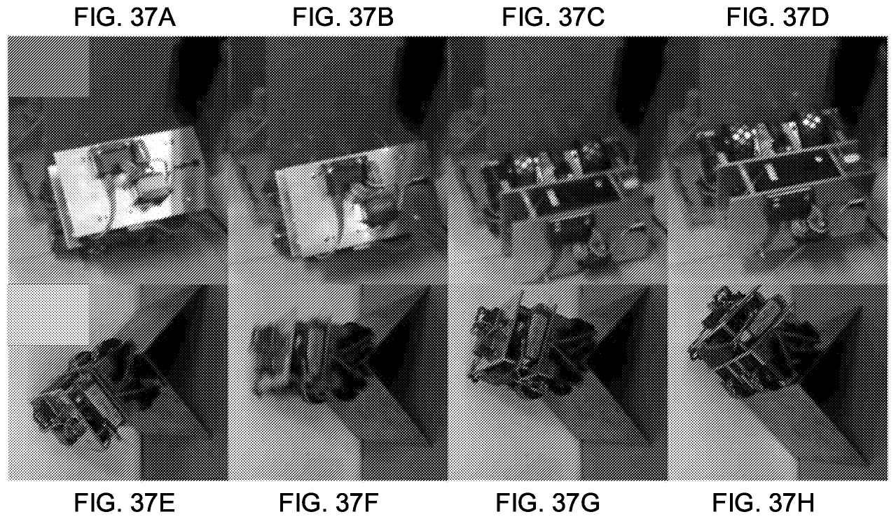

Four wheels are designed such that the robot can overcome several situations including transitioning from one surface to another surface with up to 90° change in orientation or overcoming being stuck. FIGS. 37A-D are a series of images depicting a robot traversing a 90° (interior angle) transition. FIGS. 37E-H are a series of images depicting a robot traversing a 90° (exterior angle) transition.

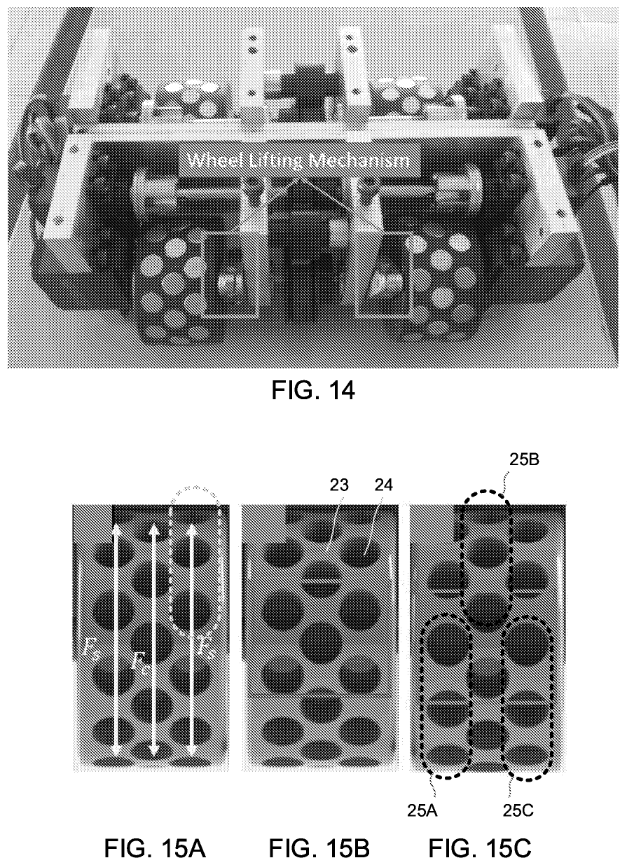

Additionally, mechanisms have been added to lift either front or rear wheels off the ground if the robot is stuck on rough terrain, as shown in FIG. 14.

### 3. Magnetic Forces

In the three-ring wheel design, the side rings and center rings of magnets can be considered separately. F_{S} and F_{C} are the magnetic forces created by magnet cylinders in an outer ring and in the center ring respectively, as shown in FIG. 15A, while F_{mag,I}(I=1:4) is the total magnetic force created by one wheel. Since the wheels are identical, assume that the magnetic force created by each wheel are also equivalent. Thus, F_{mag,I}=F_{mag,J}(I, J=1:4). As a result, the total magnetic force created by each wheel can be calculated as follows:

F_{mag,I}=2*F_{S}+F_{C} (1)

where F_{mag,I} is the Euclidean norm of magnetic force vector F̅_{mag,I}. From FIGS. 15B and 15C, there are always either four or five magnet cylinders which are within v=1 mm of the steel surface. However, each wheel is covered with an approximately 1.5 mm layer of abrasive material to increase the friction with the steel surface. Therefore, F_{S} and F_{C} can be calculated as follows:

$$\begin{matrix}\{ \begin{matrix}{F}_{{s}_{1}} = {P}_{gap = 1.5 m m}^{F} \\ {F}_{{c}_{1}} = 2 * {P}_{gap = 2.5 m m}^{F}\end{matrix} & ( 2 ) \\ or & \\ \{ \begin{matrix}{F}_{{s}_{2}} = 2 * {P}_{gap = 2.5 m m}^{F} \\ {F}_{{c}_{2}} = {P}_{gap = 1.5 m m}^{F}\end{matrix} . & ( 3 )\end{matrix}$$

Denoting by F_{mag} the total magnetic force created by all wheels by, the total magnetic force that can be used for evaluation is determined as

F_{mag}=4*F_{mag}_{ᵢ}=4*min {2Fₛ_{₁}+F_{c}_{₁};2Fₛ_{₂}+F_{c}_{₂}} (4)

This is the minimum estimate of the magnetic force since it neglects field contributions from outside the central groups of 4 or 5 magnet cylinders which make the total magnetic force larger than the estimate of Eqn. (4).

### X. Additional Design Features and Considerations

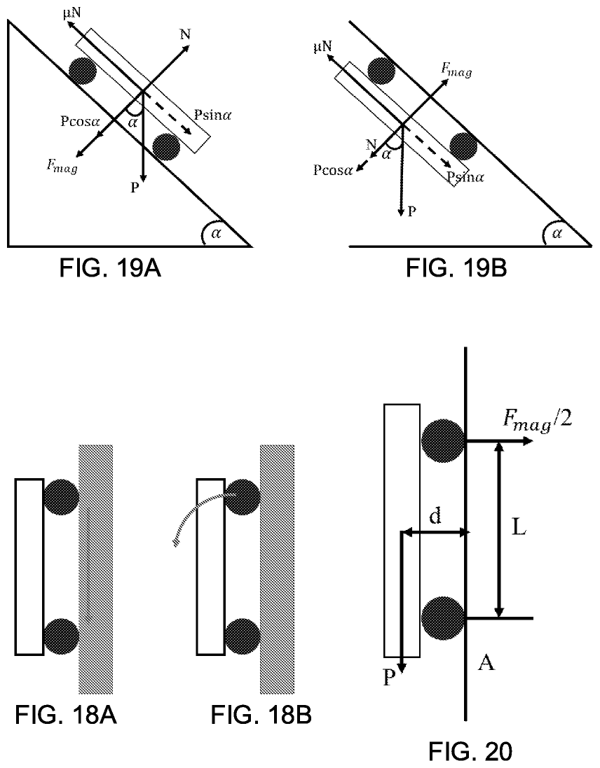

In order to maintain stability of the robot, considerations of sliding and turn-over failures, illustrated in FIGS. 18A-B, can be addressed.

### 1. Sliding Failure

It is desirable for the robot to be able to climb on different inclines. Two scenarios are shown in FIGS. 19A-B, where P is the total weight, m is the robot's mass, and g is the gravitational acceleration (thus, P=mg), F̅_{mag} is the magnetic adhesion force, N is the reaction force, μ is the friction coefficient, and α is the degree of inclination.

Denoting the total force applied to the robot as ΣF̅, with Fₓ and F_{y} being the projected components of the force on the x and y axes, respectively, as shown in FIGS. 19A-B. According to Newton's Second Law of Motion, when the robot is stationary:

Σ\vec{F}=\vec{0}. (4A)

When the robot is above an inclined surface, as shown in FIG. 19A:

$$\begin{matrix}\sum {F}_{y} = P cos α + {F}_{mag} - N = 0 ⇔ N = P cos α + {F}_{mag} & ( 4 B ) \\ \sum {F}_{x} = P sin α - μ N = 0 ⇔ N = \frac{P sin α}{μ} & ( 4 C ) \\ P cos α + {F}_{mag} = \frac{P sin α}{μ} ⇔ {F}_{mag} = \frac{P sin α}{μ} - P cos α . & ( 4 D )\end{matrix}$$

The magnetic force can satisfy following condition to avoid sliding failure:

$${F}_{mag} > \frac{P sin α}{μ} - P cos α . \qquad ( 5 )$$

When the robot is below an inclined surface, as shown in FIG. 19B:

$$\begin{matrix}\sum {F}_{y} = P cos α - {F}_{mag} + N = 0 ⇔ N = {F}_{mag} - P cos α & ( 5 A ) \\ \sum {F}_{x} = P sin α - μ N = 0 ⇔ N = \frac{P sin α}{μ} & ( 5 B ) \\ {F}_{mag} - P cos α = \frac{P sin α}{μ} ⇔ {F}_{mag} = \frac{P sin α}{μ} + P cos α . & ( 5 C )\end{matrix}$$

The magnetic force can satisfy

$${F}_{mag} > \frac{P sin α}{μ} + P cos α . \qquad ( 6 )$$

For the special case of a robot on a vertical surface (α=90°),

$${F}_{mag} > \frac{P}{μ} \qquad ( 7 )$$

To avoid sliding failure in all of these situations, the magnetic force should satisfy:

$${F}_{mag} > max \{ \frac{P sin α}{μ} - P cos α ; \frac{P}{μ} ; \frac{P sin α}{μ} + P cos α \} . \qquad ( 8 )$$

Noting that:

0<α≤90°⇒ cos α≥0 (9)

Therefore, the overall condition to avoid sliding failure is:

$${F}_{mag} > \frac{P sin α}{μ} + P cos α . \qquad ( 10 )$$

From the inequality (10), and for a constant value of magnetic force, stability can be improved by either decreasing the robot's weight P or increasing coefficient of static friction μ. In some examples, where the frictional coefficient μ between the wheels and a supporting steel surface lies between 0.5 and 0.8, it is seen that

$$( \frac{sin α}{μ} + cos α )$$

decreases when μ increases and:

$$\begin{matrix}0 < μ < 0.8 ; 0 < α \leq 90 & ( 11 A ) \\ ⇒ max \{ \frac{sin α}{μ} + cos α \} \approx 2.2361 & ( 11 B ) \\ ⇒ {F}_{mag} \geq 2.237 P . & ( 11 C )\end{matrix}$$

Thus, the magnetic force created by the permanent magnets can be at least 2.237 times the weight of the robot in some embodiments to provide improved operation characteristics.

### 2. Turn-Over Failure

In FIG. 20, L is the distance between front and rear wheels, and d is the distance from the robot's center of mass to a steel surface. For stability, the turning moments M about A should sum to zero:

$$\sum M = P * d - \frac{{F}_{mag}}{2} * L = 0 ⇔ {F}_{mag} = 2 \frac{Pd}{L} \qquad ( 10 )$$

Thus, to avoid turn-over failure:

$${F}_{mag} > 2 \frac{Pd}{L} \qquad ( 12 )$$

For a fixed magnetic force, turn-over failure can be avoided by reducing d/L, or making the robot's center of mass closer to the steel surface.

Sliding and turn-over failure can both be avoided if the magnetic force satisfies:

$${F}_{mag} > max \{ 2.237 P ; 2 \frac{Pd}{L} \} \qquad ( 13 )$$

### 3. Magnetic Force on a Curved Surface

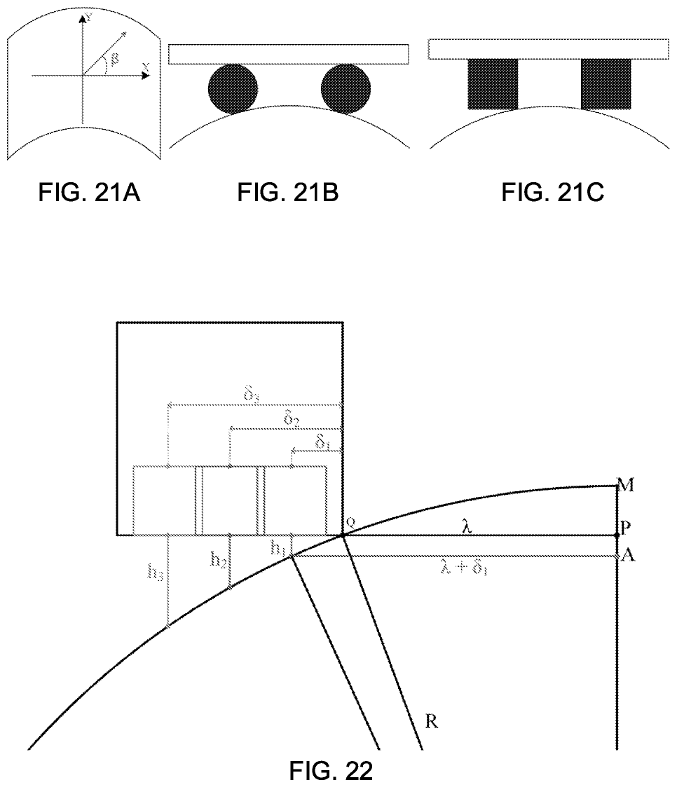

The analyses above are applicable when the robot moves on a flat steel surface. In some situations, a robot can traverse a curved surface, such as a pipe or cylindrical pillar. FIG. 21A shows a robot on top of a curved surface, with an angle β between by the robot's direction of travel and the X axis. as shown in FIGS. 21B and 21C, the magnetic force created by the wheel magnets is maximized when the robot travels along the X axis (β={0°; 180°}) and minimized when traveling along the Y axis (β=±90°).

FIG. 22 is an annotated diagram of a wheel on a curved surface in an orientation similar to FIG. 21C. R is the radius of the curved surface; h₁, h₂, h₃ are distances from the bottom center of each magnet ring to the surface; 2λ is the distance between two inner sides of left and right wheels and δ₁, δ₂, δ₃ are distances from wheel's inner side to the center of magnet cylinders. Using Pythagoras' theorem, h₁, h₂, h₃ are found:

$$\{ \begin{matrix}{h}_{1} = \sqrt{{R}^{2} - {λ}^{2}} - \sqrt{{R}^{2} - {( λ + {δ}_{1} )}^{2}} \\ {h}_{2} = \sqrt{{R}^{2} - {λ}^{2}} - \sqrt{{R}^{2} - {( λ + {δ}_{2} )}^{2}} \\ {h}_{3} = \sqrt{{R}^{2} - {λ}^{2}} - \sqrt{{R}^{2} - {( λ + {δ}_{3} )}^{2}}\end{matrix} \qquad ( 14 )$$

λ, δ are known from the robot's design. Thus, h_{I} (I=1:3) only depends on R: h_{I}=g_{I}(R). The first derivative h′_{I} can be determined as shown in Eqn. (15). h′_{I}<0∀R≥λ+δ_{I}; therefore, h_{I} decreases when R increases and vice versa.

$${h}_{i}^{′} = 2 R ( \frac{1}{\sqrt{{R}^{2} - {λ}^{2}}} - \frac{1}{\sqrt{{R}^{2} - {( λ + {δ}_{1} )}^{2}}} ) \qquad ( 15 )$$

Polynomial curve fitting technique can be used to determine a relationship between pull force and air gap h_{I} in this circumstance. Imposing the known dependence of force on the inverse cube of the distance,

$$F ∼ \frac{1}{{h}^{3}} ,$$

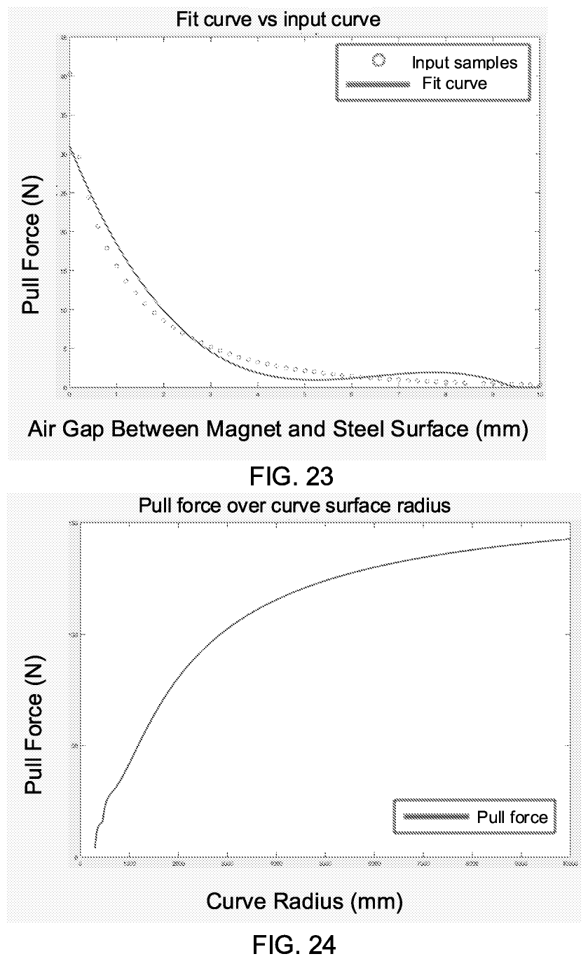

the polynomial fit with degree 3 has been determined, and is shown in FIG. 23.

Because each robot's wheel is covered by a 1.5 mm thick abrasive layer, define

hᵢ′=hᵢ+0.0015(i=1,2,3) (15A)

to account for the coating layer. From Eqn. (1), the minimum magnetic force F_{mag,I} created by one wheel can be calculated as

F_{mag}_{ᵢ}=min [F₁(h₁′,h₂′,h₃′); F₂(h₁′,h₂′,h₃′)]=ζ(R) (15B)

where

F₁=1(f(h₁′)+f(h₃′))+f(h₂′+ν) (15C)

F₂=(f(h₁′)+f(h₃′))+2f(h₂′+ν) (15D)

and ν=1 mm.

In order to avoid any failures when robot travels on curve surfaces, the total magnetic force created by all wheels should satisfy (13), or

$$4 * ζ ( R ) > max \{ 2.237 P ; 2 \frac{Pd}{L} \} \qquad ( 15 E )$$

Eqn. (15E) can be solved for R to find the minimum radius of curvature for which the robot can safely traverse. FIG. 24 shows how the magnetic pull force varies with different values of curve radius.

### 4. Motor Torque

Motor torque analysis was performed to determine motor requirements. For the robot to move, the force created by the motor should exceed the static friction between the wheel and the steel surface. Denoting the torque of one motor by τ, the radius of one wheel by r, the coefficient of static friction by μₛ, and the total normal force by N, the following condition for total motor force can be derived:

$$\begin{matrix}{F}_{all motors} > {F}_{static friction} & ( 15 F ) \\ ⇔ 4 * \frac{τ}{r} > {μ}_{s} N ⇔ τ > \frac{{μ}_{s} rN}{4} & \end{matrix}$$

From FIG. 19, the normal force N is maximum when the robot is on top of a horizontal surface (N=F_{mag}+P). Hence, the torque requirement for one motor is:

$$τ > \frac{{μ}_{s} r ( {F}_{mag} + P )}{4} \qquad ( 16 )$$

### 5. Wheel Control

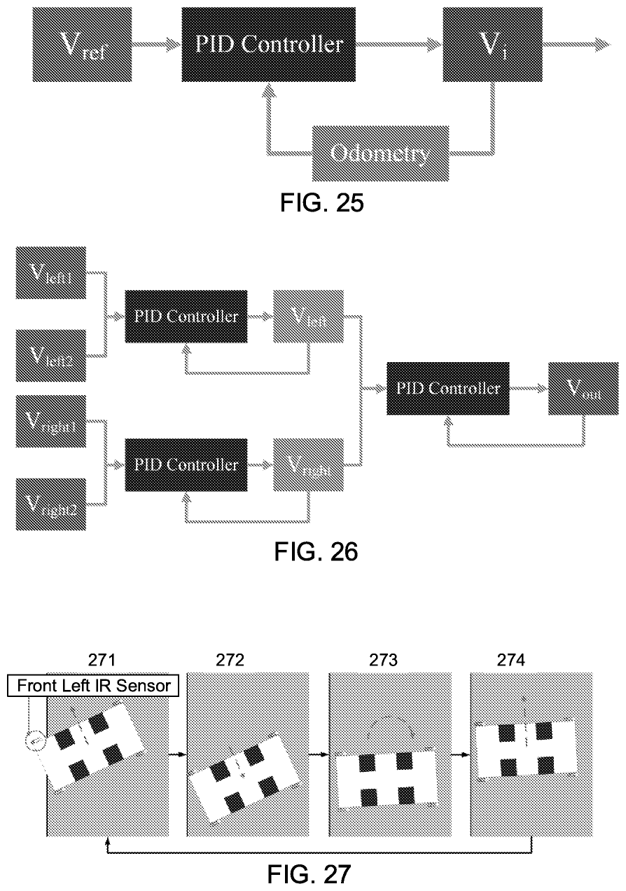

The Hall effect sensors can be used to provide wheel odometry, and allow a velocity controller to be integrated into the robot control subsystem as shown in FIG. 25. Four velocity controllers are implemented to match the speed of each wheel with the reference input velocity to achieve output velocities V_{I}(I=left₁, left₂, right₁, right₂). However, factors such as environmental noise, model imperfections, or component variations can lead to small mismatches in the actual wheel velocities. To correct these mismatches, additional controllers are used, as shown in FIG. 26. Velocities on each side of the robot (left, right) are synchronized; these velocities are then fed to another controller to ensure equality among all wheel velocities, and thereby achieve a desired trajectory for the robot motion.

### 6. Edge Avoidance

It is desirable that the robot be prevented from traveling off the edge of a steel surface. The infrared (IR) range sensors can be used to detect presence or absence of a steel surface beneath the corners of the robot, and thereby identify when the robot is near an edge. The following procedure is used for edge avoidance. r_cal_{I} (I=1:4) are the calibrated ranges before robot starts moving, r_{I} (I=1:4) are IR sensor readings corresponding to sensor_{I}, and dr (I=1:4) are travel distances calculated from Hall Effect sensors. When the sensor_{I} reading r_{I} is within the range [r_cal_{I}−ε; r_cal_{I}+ε], a surface is detected; otherwise the surface is absent. The threshold ε can be, for example, about 5 mm. When the surface is absent, the robot's heading is changed to avoid falling off the edge. The edge avoidance procedure for safe navigation is described in FIG. 27 and Procedure 1.

Procedure 1: EDGE AVOIDANCE

| | Input: (r_cal₁, r_cal₂, r_cal₃, r_cal₄, (r₁, r₂, r₃, r₄), | | | | |
|---|---|---|---|---|---|
| | | (d₁, d₂, d₃, d₄), ε, (s₁, s₂) | | | |
| 1 | while robot is moving do | | | | |
| 2 | \| | for i=1:4 do | | | |
| 3 | \| | \| | if only one (rᵢ) ∉ [r_calᵢ − ε;r_calᵢ + ε] then | | |
| 4 | \| | \| | \| | if i= front left IR sensor then | |
| 5 | \| | \| | \| | \| | Stop |
| 6 | \| | \| | \| | \| | Go backward with a distance of s₁ |
| 7 | \| | \| | \| | \| | Rotate left when travel distance of either |
| | \| | \| | \| | \| | right wheel reach s₂ |
| 8 | \| | \| | \| | \| | Keep moving |

| 9 | \| | \| | \| | Check other sensors and take similar actions |
|---|---|---|---|---|
| 10 | \| | \| | else | |
| 11 | \| | \| | \|_{—} | stop and wait for commands |
| | \| | \|_{—} | | |
| | \|_{—} | | | |

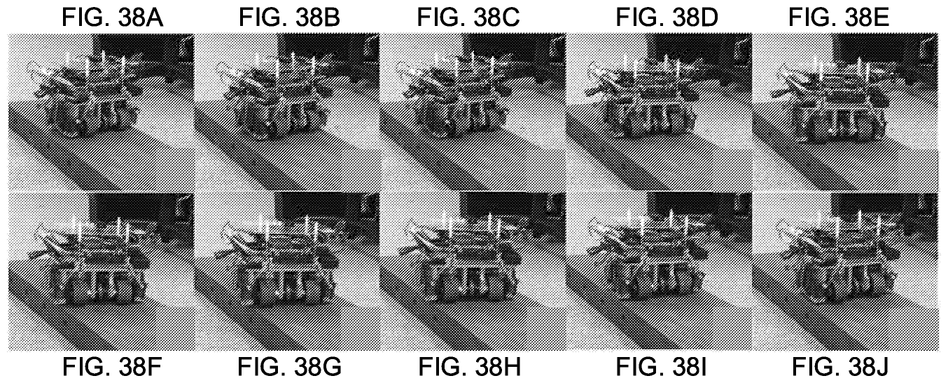

FIGS. 38A-H are a series of images demonstrating edge avoidance.

### 7. Path Planning

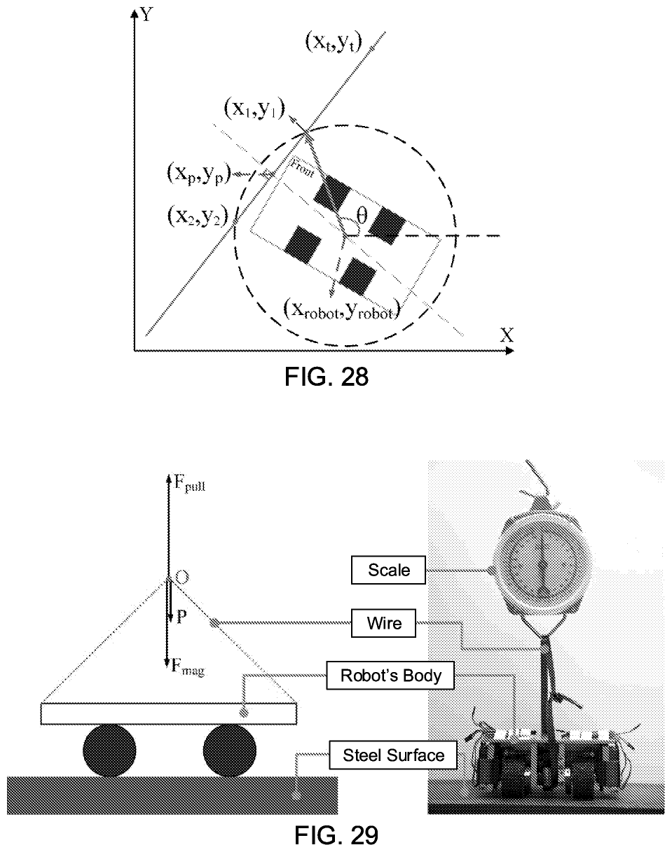

For automatic navigation, bicycle path planning and pure pursuit methods have been used in the navigation subsystem. The kinematics is examined in context of FIG. 28. For V_{I} (I=1:4) as the linear velocity of each wheel (V_{1,2} for the right wheels and V_{3,4} for the left wheels), and s as the distance between left and right wheels, the kinematics equations can be expressed as:

$$[ \begin{matrix}\dot{x} \\ \dot{y} \\ \dot{θ}\end{matrix} ] = [ \begin{matrix}cos θ & cos θ & cos θ & cos θ \\ sin θ & sin θ & sin θ & sin θ \\ \frac{1}{s} & \frac{1}{s} & - \frac{1}{s} & - \frac{1}{s}\end{matrix} ] [ \begin{matrix}{v}_{1} \\ {v}_{2} \\ {v}_{3} \\ {v}_{4}\end{matrix} ] \qquad ( 17 )$$

The goal of bicycle path planning is to determine the intersections between a straight line (the desired path) and a circle whose center point is the robot's center. FIG. 28 shows that there are two intersecting points (x₁, y₁) and (x₂, y₂) between the line and the circle. The robot should follow the point on its front of it, which is (x₁, y₁). The movement of the robot can be controlled using the radius of the circle as a parameter. The robot will move toward the intersecting point between the path and circle, such as (x₁, y₁).

Denoting by γ the gradient of the line intersecting the circle, Eqns. (18) and (19) represent the line and circle, respectively.

y=γx+C (18)

(x−a)²+(y−b)²=r² (19)

where (a,b) is the center of the circle with radius r.

If the line is not parallel to y-axis, two intersecting points between the line and circle are the roots of the quadratic equation Ax²+Bx+C=0 where (A, B, C) can be calculated as:

$$\begin{matrix}\{ \begin{matrix}A = ( 1 + {γ}^{2} ) \\ B = - 2 a + 2 γ c - 2 b \\ C = {a}^{2} + {( c - b )}^{2} - {r}^{2}\end{matrix} & ( 19 A ) \\ ⇒ \{ \begin{matrix}{x}_{1 , 2} = \frac{- B \pm \sqrt{{B}^{2} - 4 AC}}{2 A} \\ {y}_{1 , 2} = γ {x}_{1 , 2} + c\end{matrix} . & ( 19 B )\end{matrix}$$

Otherwise, when the line is parallel toy-axis, x=Xₚ is a constant. Substituting for x in Eqn. (19), a quadratic equation y is obtained, A⁰y²+B⁰y+C⁰=0 where (A⁰, B⁰, C⁰) can be calculated as:

$$\begin{matrix}\{ \begin{matrix}{A}^{′} = 1 \\ {B}^{′} = - 2 b \\ {C}^{′} = {b}^{2} - {r}^{2} + {X}_{p}^{2}\end{matrix} & ( 19 C ) \\ ⇒ \{ \begin{matrix}{x}_{1 , 2} = {X}_{p} \\ {y}_{1 , 2} = \frac{- {B}^{′} \pm \sqrt{{B}^{{′}^{2}} - 4 {A}^{′} {C}^{′}}}{2 {A}^{′}}\end{matrix} & ( 19 D )\end{matrix}$$

Since there are two points of intersection as shown in FIG. 28, it is possible to resolve the one which lies in front of the robot. Denoting by γ⁰ the gradient of the line intersecting robot's center and perpendicular to the robot trajectory, the following equations are derived:

$$\begin{matrix}{γ}^{′} = - \frac{1}{γ} & ( 19 E ) \\ γ ( {x}_{p} - {x}_{t} ) + {y}_{t} = {γ}^{′} ( {x}_{p} - {x}_{robot} ) + {y}_{robot} & ( 19 F ) \\ γ {x}_{p} - γ {x}_{t} + {y}_{t} = {γ}^{′} {x}_{p} - γ {x}_{robot} + {y}_{robot} & ( 19 G ) \\ {x}_{p} ( γ - {γ}^{′} ) = - {γ}^{′} {x}_{robot} + {y}_{robot} + γ {x}_{t} - {y}_{t} & ( 19 H ) \\ ⇒ \{ \begin{matrix}{x}_{p} = \frac{γ {x}_{y} - {γ}^{′} {x}_{robot} + {y}_{robot} - {y}_{t}}{γ - {γ}^{′}} \\ {y}_{p} = γ ( {x}_{p} - {x}_{t} ) + {y}_{t}\end{matrix} . & ( 19 I )\end{matrix}$$

where (xₜ, yₜ); (X_{robot}, y_{robot}); (xₚ, yₚ) are coordinates of points shown in FIG. 28. The robot's heading toward each intersection point and target can be calculated as

$${θ}_{1 , 2} = \frac{{x}_{1 / 2} - {x}_{p}}{{y}_{1 / 2} - {y}_{p}} ; {θ}_{target} = \frac{{x}_{t} - {x}_{p}}{{y}_{t} - {y}_{p}} \qquad ( 19 J )$$

If θ₁=θ_{target} then (x₁, y₁) is the point in front of the robot. Otherwise, (x₂, y₂) is the desired point. This leads to the desired heading of the robot:

$${θ}_{heading} = {tan}^{- 1} ( \frac{{x}_{1 , 2} - {x}_{robot}}{{y}_{1 , 2} - {y}_{robot}} ) \qquad ( 20 )$$

The robot velocity can also be calculated as shown in Eqn. (21).

$$⇒ \{ \begin{matrix}{V}_{x} = {V}_{d} * sin ( {θ}_{heading} ) \\ {V}_{y} = {V}_{d} * cos ( {θ}_{heading} )\end{matrix} \qquad ( 21 )$$

where V_{x,y} are velocity components along the x,y-axes and V_{d} is the current desired robot speed.

### XI. Exemplary Inspection Systems

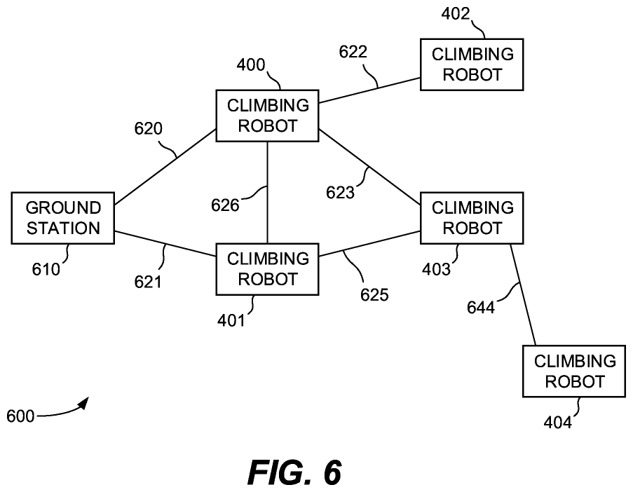

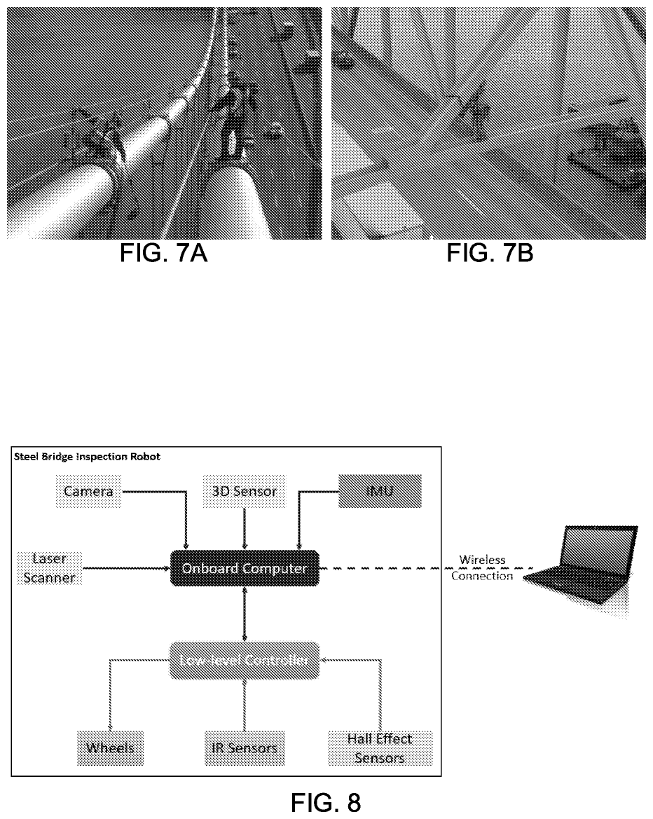

FIG. 6 is a schematic diagram of an inspection system 600. Climbing robot 400 is connected to a ground station 610 such as a portable computer over a wireless link 620. The ground station 610 is configured to transmit control information over the wireless link 620 to robot 400. Thereby detailed remote inspection of bridges and other structures is enabled, without requiring inspectors to personally engage in hazardous access of the structures. FIGS. 7A-B are images of bridge inspectors performing bridge inspections in dangerous settings.

Also shown in FIG. 6 are additional climbing robots 401-404, and additional wireless links 621-625. The use of multiple robots provides advantages including speed of coverage, so that an entire structure can be inspected by five robots 400-404 within a portion of a workday, what might take several days with a single robot 400. Additionally, metal bridges and structures may incorporate remote, shielded, or interior locations which may be inaccessible from a ground station by a line-of-sight wireless link or even by a non-line-of-sight (NLOS) wireless link. In such situations, climbing robot 400 can provide a wireless relay or bridge function to enable a two-hop wireless link between ground station 610 and climbing robot 403. The wireless topology of the network (formed by wireless links 621-625) can change over the course of an inspection as the climbing robots 400-404 move over the bridge or other structure, as links are lost and new links are formed as the climbing robots 400-404 traverse an inspected structure.

In some examples, inspection systems with two or more ground stations (not shown) can be used. Functions can be allocated between ground stations based on areas of the inspected structure, based on groups of climbing robots, based on type of function (one ground station can manage control functions, while another ground station can manage data gathering), based on types of sensors, or on another basis.

### XII. Experimental Results for an Exemplary Climbing Robot

Experiments were conducted to verify the design, particularly to verify the total magnetic force created by all wheels, and to assess the performance of the robot. Both indoor and outdoor experiments were conducted to validate the effectiveness of the robot. The indoor test was under lab environment on small steel bars while the outdoor experiment was on a bridge connecting two buildings within the campus of the University of Nevada, Reno, Nev. The ability of climbing and failure avoidance were evaluated under both experiments. During the test, one 2S1P (2 cells) 7.4 V 5000 milliampere-hour (mAh) battery and one 3S1P 11.1 V 5000 mAh battery were used to power the robot. A laptop with wireless LAN connectivity served as a ground station. The robot's mass m=6 kg; assuming gravitational acceleration g=10 m/s², the total weight of the robot is approximately P=mg=60 N. Applying Eqns. (2), (3), and (4) for 10 mm×10 mm magnet cylinders, the total magnetic force can be calculated as

$$\{ \begin{matrix}{F}_{{s}_{1}} = 11.4 ( N ) ; {F}_{{c}_{1}} = 13.2 ( N ) \\ {F}_{{s}_{2}} = 13.2 ( N ) ; {F}_{{c}_{2}} = 11.4 ( N ) \\ {F}_{mag} = 4 * min \{ 2 {F}_{{s}_{1}} + {F}_{{c}_{1}} ; 2 {F}_{{s}_{2}} + {F}_{{c}_{2}} \} = 144 ( N )\end{matrix} . \qquad ( 22 )$$

which satisfies the magnetic force condition for a flat steel surface from Eqn. (13). According to Eqn. (16), the minimum torque required for this particular case is approximately 0.21 Nm. The motor used in the test robot has considerably high torque (3.31 Nm), and worked well.

### 1. Pull Force Measurements

FIG. 29 shows a measurement setup used to measure the pull force created by permanent magnets. The robot's body having mass m⁰=3.5 kg was placed on top of a flat steel surface while connected to a weighing scale through an inelastic wire. Lifting the robot by the scale creates a pull force that can be measured on the scale. At the moment of separation between the robot and the surface, the force measured on the scale equals the sum of the robot's weight and the magnetic pull force. Denote the force applied by the scale on the robot as Fₚᵤₗₗ, the mass value shown on the scale as M, while P is the weight of robot's body and F_{mag} is the magnetic force. Then, with g=10 m/s², P=m⁰g=35 N and Fₚᵤₗₗ=Mg=10M, and the magnetic force is obtained as follows:

Fₚᵤₗₗ=P+F_{mag}⇒F_{mag}=Fₚᵤₗₗ−P⇒F_{mag}=10M−35(N). (23)

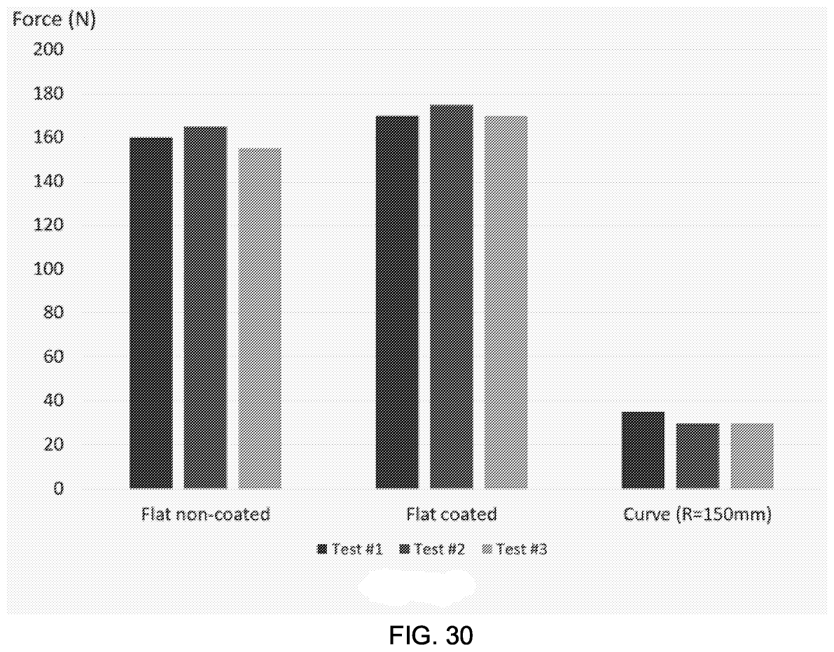

Multiple tests were conducted to measure the pull force with the robot's body placed on different surfaces. The first test was on a flat non-coated steel surface, the second test was on a flat steel surface while the third test was on a curved surface (a steel pipe with radius R=150 mm). These tests were executed three times each; the results are presented in FIG. 30.

The measured pull force on flat surface is larger than that calculated in Eqn. (22) because of the presence of additional nearby magnets beyond those considered to derive Eqn. (22). The pull force was significantly decreased on a curved surface, consistent with the analysis above at section (X)(3).

### 2. Indoor Experiments

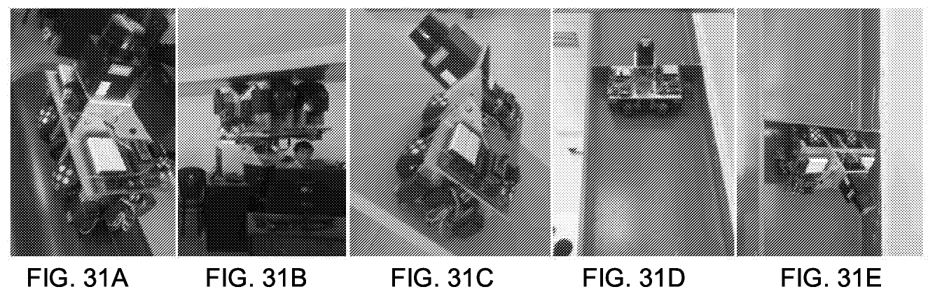

FIGS. 31A-31A present various cases in which the robot was placed on flat steel surfaces under different degrees of inclination to ensure that the magnetic force is strong enough for the robot to adhere to steel surfaces in a stationary position without driving power. In these cases, the robot demonstrated a strong adhesion force without sliding or turnover failure.

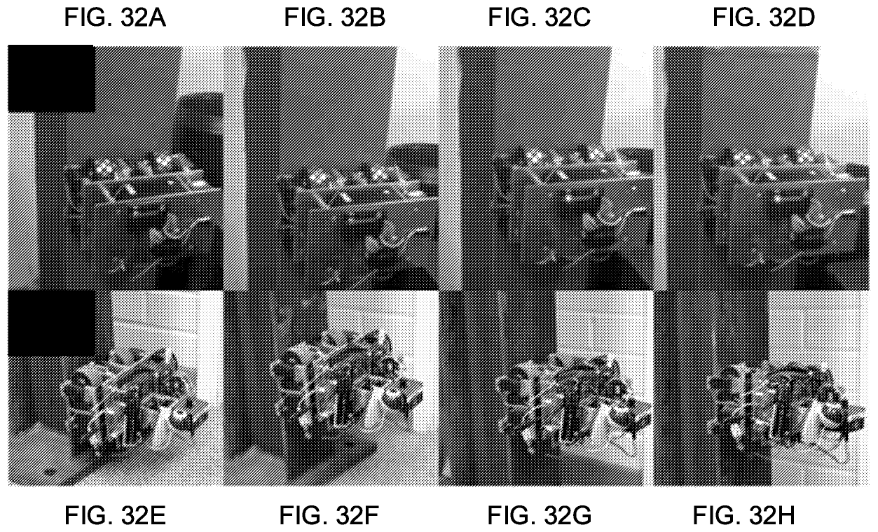

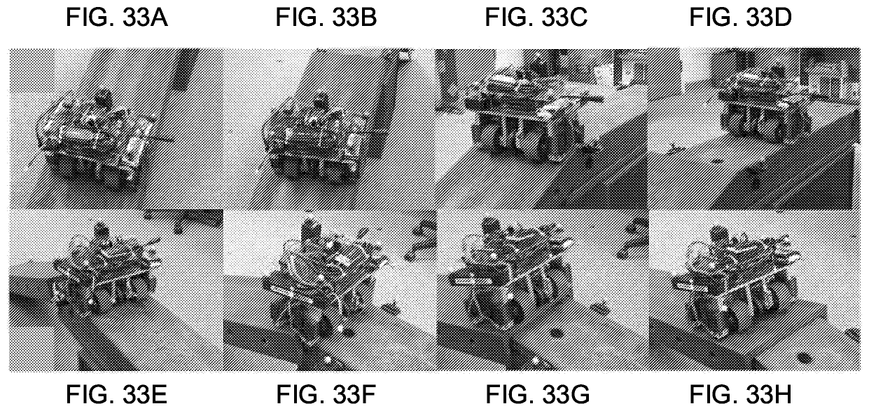

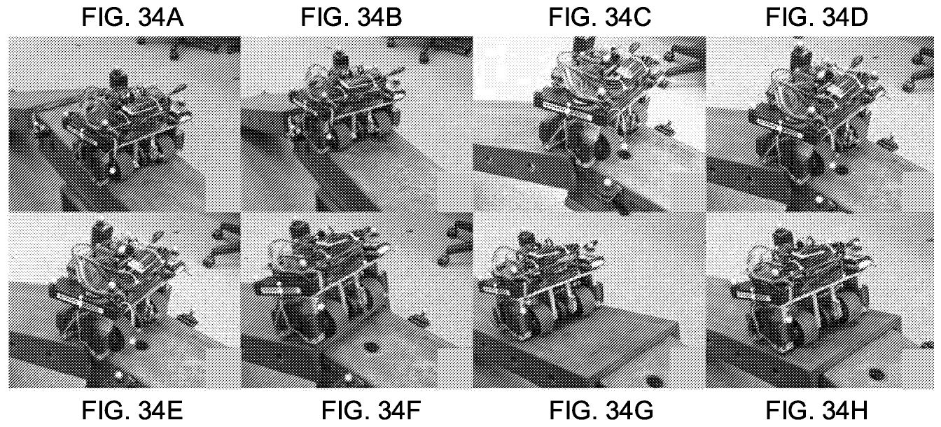

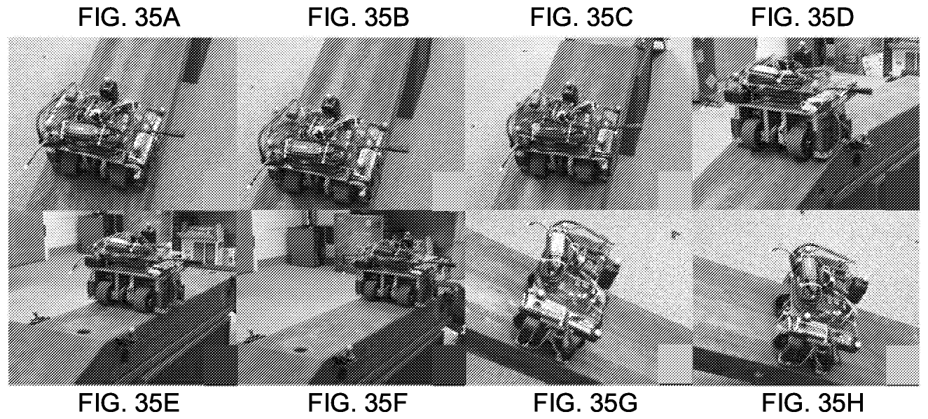

FIGS. 32A-32H depicts situations with the robot moving vertically on a steel surface for both no-load and fully-loaded cases. The velocity of the robot was approximately 10 centimeters/second. In another test, the robot was driven on a constructed steel structures from one end to the other end. The robot successfully reached the destination and demonstrated use of the lifting mechanism to overcome a stuck condition while passing joint, as shown in FIGS. 33A-33H. FIGS. 34A-34H and FIGS. 35A-35H depict similar image sequences.

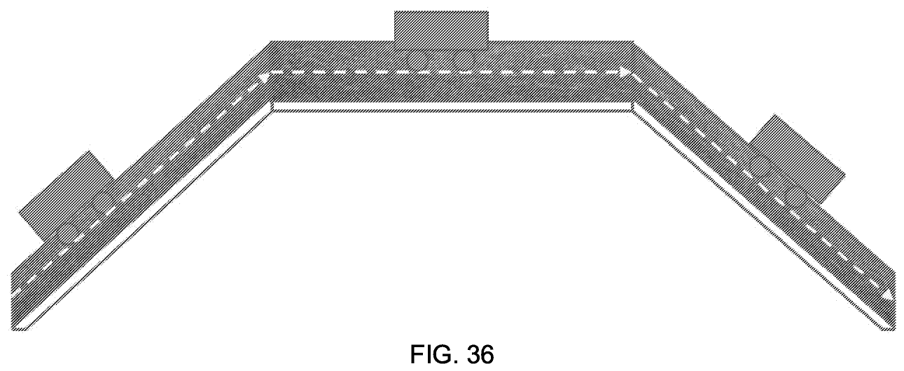

FIG. 36 is a schematic diagram depicting a robot's path along a segmented structure.

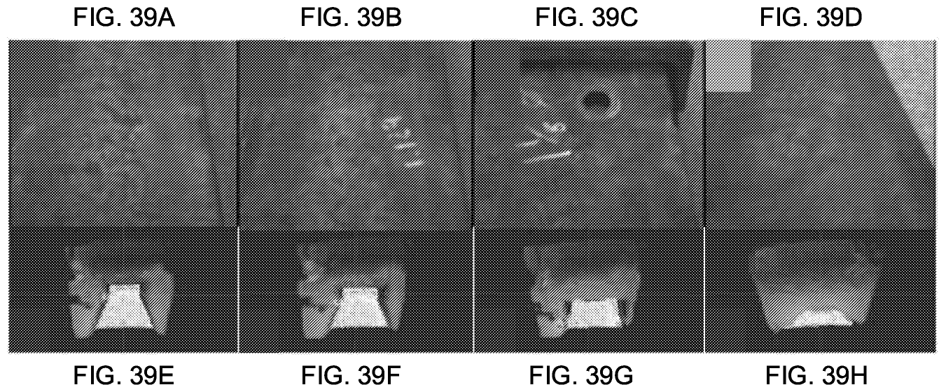

For these tests, the robot was controlled remotely from the ground station while data collected from both video camera and depth camera was transmitted over a wireless connection to the ground station as shown in FIG. 39.

### 3. Outdoor Experiments

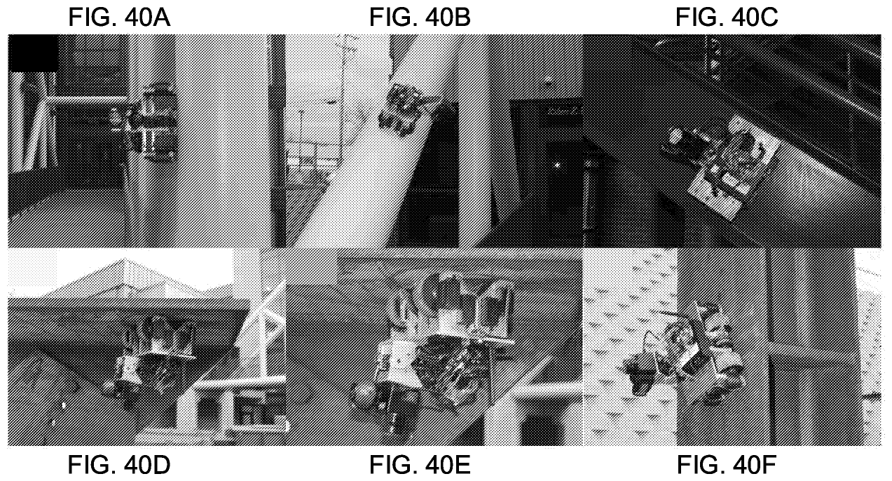

Climbing capability tests were done on a bridge and other structures, having coated or unclean surfaces, as seen on FIGS. 40A-F. The robot adhered tightly to the steel structures, even on curved surface, and showed strong climbing capability even on a rusty steel surface.

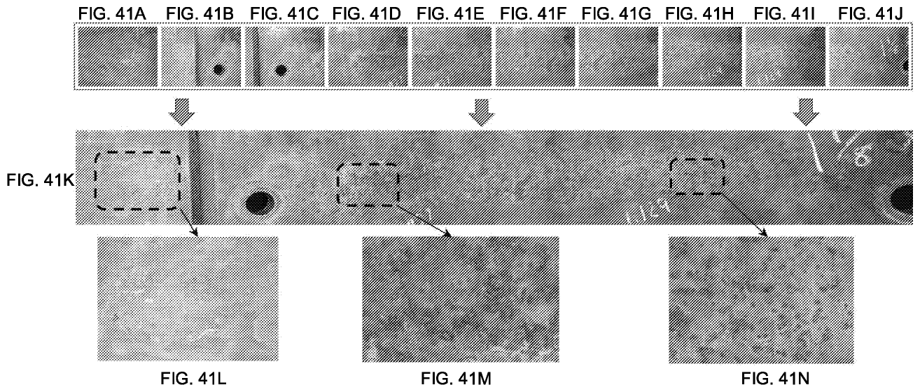

The robot was controlled to move and stop at regular distance intervals (e.g., every 12 cm) to capture images of the supporting steel surface and transmit the images to the ground station. For enhanced inspection, the acquired images were stitched together to produce an overall image of the steel surface as shown in FIGS. 41A-N.

### XIII. Further Exemplary Aspects

The following aspects of the disclosed technology can be used singly or in any combination or subcombination with each other or with any of the other embodiments disclosed herein.

Magnets can be retained within a wheel body by adhesive, friction, magnetic force, or mechanical fitments. The wheel body can be formed of materials such as Aluminum, natural or synthetic rubber, or a compliant material or an elastomer, a composite material, or a polymer material. Magnets can be permanent magnets. Magnets can be formed of materials such as a ferromagnetic material; a rare-earth material; Neodymium; a Neodymium-iron-boron or NIB alloy; Samarium; a Samarium-Cobalt alloy; an Iron-Nitrogen crystalline, polycrystalline, or microcrystalline material; or a composition of at least Samarium, Cobalt, Iron, Copper, And Zinc. Magnets can have outward facing pole faces that are planar. The outwardly facing pole faces can have polarities in an alternating pattern. A magnetic wheel can have exactly 2, 3, 4, 5, 6, 7, 8, 9, 10, 11, 12, or in the range of 13-20, or in the range of 21-100 rings of magnets. A ring of magnets can have exactly 3, 4, 5, 6, 7, 8, 9, 10, 11, 12, 13, 14, 15, 16, 17, 18, 19, 20, 21, 22, 23, 24, 25, 26, 27, 28, 29, 30, or in the range of 31-50, or in the range of 51-200 individual magnets. A magnetic wheel can have a coating over an entire circumferential surface of the magnetic wheel, or a coating over a portion of a circumferential surface of the magnetic wheel excluding outward facing pole faces. The coating can be an abrasive material, a non-skid material, a wear-resistant material, or a ferromagnetic material.

A rotatable member can include a retainer within which magnetic members are held in position. The magnetic members can be held within the retainer by adhesive, friction, magnetic force, or mechanical fitments. The retainer can be formed of materials such as Aluminum, natural or synthetic rubber, or a compliant material or an elastomer, a composite material, or a polymer material. Magnetic members can include permanent magnets. Magnetic members can be formed of materials such as a ferromagnetic material; a rare-earth material; Neodymium; a Neodymium-iron-boron or NIB alloy; Samarium; a Samarium-Cobalt alloy; an Iron-Nitrogen crystalline, polycrystalline, or microcrystalline material; or a composition of at least Samarium, Cobalt, Iron, Copper, And Zinc. Magnetic members can be cylindrical. Magnetic members can have outward facing pole faces that are planar, or outward facing pole faces that are curved. The outwardly facing pole faces can have polarities in an alternating pattern, or can have the same polarity. The magnetic members can be arranged in exactly 2, 3, 4, 5, 6, 7, 8, 9, 10, 11, 12, or in the range of 13-20, or in the range of 21-100 rings; each ring can encircle an axis of rotation of the rotatable member. A ring can have exactly 3, 4, 5, 6, 7, 8, 9, 10, 11, 12, 13, 14, 15, 16, 17, 18, 19, 20, 21, 22, 23, 24, 25, 26, 27, 28, 29, 30, or in the range of 31-50, or in the range of 51-200 individual magnetic members. The rings can have same number or varying numbers of magnetic members, respectively. A rotatable member can have a coating over outwardly facing pole faces, a coating over an entire circumferential surface of the rotatable member, or a coating over a portion of a circumferential surface of the rotatable member excluding outward facing pole faces. The coating can be an abrasive material, a non-skid material, a wear-resistant material, or a ferromagnetic material. The rotatable member can be devoid of ferromagnetic pole pieces.

A climbing robot can include magnetic wheels or rotatable members, in any number such as 1, 2, 3, 4, 5, 6, 7, 8, 9, 10, 11, 12, or in the range of 13-20, in the range of 21-50, or in the range of 51-100. An axle of a climbing robot can be a fixed axle. A motor of a climbing robot can be an AC motor, a brushed DC motor, a brushless DC motor, a geared DC motor, a servo motor, a stepper motor, or a DC linear actuator. A drivetrain of a climbing robot can be of a crab type, a holonomic type, a swerve type, or a tank type. A low-level controller of a climbing robot can be configured to generating PWM control signals for motors of the climbing robot. A high-level controller of a climbing robot can be configured to manage communication subsystem; perform unidirectional or bidirectional communication between the climbing robot and a ground station; communicate with one or more other climbing robots; provide instruction to the low-level controller; receive data from the low-level controller; control a payload package; receive data from the payload package; analyze sensor data; fuse data from navigation sensors, payload sensors, system sensors, and/or advanced sensors; or execute navigation procedures. Navigation procedures can include an edge avoidance procedure, a path planning procedure, a joint traversal procedure, an obstacle negotiation procedure, a route planning procedure, a linear traversal procedure, an areal traversal procedure, or a structural frame traversal procedure. A communications subsystem of a climbing robot can initialize and maintain one or more wireless, wired, or optical links with ground stations or other climbing robots. A power source of a climbing robot can include an electrochemical battery, a fuel cell, a Lithium polymer battery, a rechargeable battery, a solar cell, or a beamed power receiver. A chassis of a climbing robot can include a separate body chassis, an integral chassis, an articulated chassis, a metal frame, a composite frame, a tubular frame, a graphite structure, a polymer structure, or a composite structure. The chassis can be formed of materials such as a high-entropy alloy, a carbon tube or carbon nanotube material, an ultrahigh molecular weight polyethylene material, carbon fiber composite material, an aramid fiber material, or a polyoxazole material.

In the manufacture of a magnetic wheel, a receptacle formed in a wheel block can be a through hole, a blind hole, or an undersized hole. The wheel block can be formed by a process such as machining, CNC milling, 3-D printing, casting, molding, additive layer manufacturing, laminating, or epitaxy. Wheel manufacture can include static or dynamic balancing, or coating with a wear resistant material.

### XIV. Summary

This disclosure describes the design and implementation of a steel climbing robot which is capable of carrying multiple sensors for steel bridge or steel structure inspection. In addition to inspection sensors, the robot also incorporates sensors to assist with navigation. The robots described herein are able to adhere to flat and curve steel surface in different situations.

A prototype has been implemented and tested to verify the adhesion strength and validate the design and robot capabilities across a range of situations and surfaces. The results show that the magnetic force requirement is met even on curved surfaces, and the robot is able to move safely on steel surface without any failures.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims.

1-50. (canceled)

51. A magnetic wheel having an axis of rotation and comprising:
a plurality of rings of magnets evenly disposed about distinct respective points on the axis of rotation of the magnetic wheel, wherein each magnet of the rings of magnets has a magnetic axis radially aligned with respect to the wheel and a first pole face facing radially outward; and
an abrasive material coating over the first pole face of the each magnet;
wherein the magnets of two neighboring rings are azimuthally staggered.

52. The magnetic wheel of claim 51, further comprising a body within which the magnets are retained, wherein the body comprises a compliant material.

53. The magnetic wheel of claim 51, wherein at least one first pole face is curved.

54. The magnetic wheel of claim 51, wherein all first pole faces have a same polarity.

55. A climbing robot comprising:
four magnetic wheels according to claim 51;
one or more axles upon which the magnetic wheels are mounted;
one or more motors;
one or more drivetrains coupled between respective motors and respective axles;
a control and/or navigation subsystem;
a communications subsystem;
a payload package;
one or more power units coupled to one or more of the motors, the control and/or navigation subsystem, the communication system, or the payload package; and
a chassis mechanically coupled to the one or more axles, the one or more motors, the one or more drivetrains, the control and navigation subsystem, the payload package, and the one or more power units.

56. The climbing robot of claim 55, further comprising one or more wheel-lifting mechanisms comprising one or more of a shaft, a cam, a rotatable motor, or a linear actuator.

57. The climbing robot of claim 55, wherein at least one of the drivetrains incorporates a transmission, a gear transmission, or a flex coupler.

58. The climbing robot of claim 55, wherein the control and/or navigation system comprises:
separate low-level and high-level controllers;
an on-board navigation system; and
one or more navigation sensors.

59. The climbing robot of claim 58, wherein the low-level controller is configured to perform one or more of the following tasks:
receiving velocity and/or heading commands from the high-level controller;
reading the one or more navigation sensors;
transmitting navigation sensor data to the high-level controller;
analyzing navigation sensor data to determine velocity and/or heading information; or
transmitting velocity and/or heading information to the high-level controller.

60. The climbing robot of claim 58, wherein the high-level controller is configured to perform fusion of data from the one or more navigation sensors, payload sensors, system sensors, and/or advanced sensors.

61. The climbing robot of claim 58, wherein the high-level controller is configured to execute navigation procedures comprising:
an edge avoidance procedure,
a joint traversal procedure, or
an obstacle negotiation procedure.

62. The climbing robot of claim 55, wherein the payload package comprises a video camera, an eddy current sensor, and an ultrasound sensor.

63. A method of using the climbing robot of claim 55, comprising:
navigating on one or more steel surfaces of a steel structure;
encountering an obstacle;
activating one or more wheel-lifting mechanisms to raise a portion of the climbing robot off the steel structure;
driving at least one magnetic wheel;
proceeding over the obstacle; and
subsequently, acquiring sensor data pertaining to the steel structure.

64. The method of claim 63, wherein the steel structure is a bridge.

65. A system for inspecting a steel structure comprising:
a climbing robot according to claim 55;
a computing device; and
a wireless link coupled between the computing device and the climbing robot and configured to:
transmit control information from the computing device to the climbing robot; and
transmit sensor information or condition information from the climbing robot to the computing device.

66. A system for inspecting a steel structure comprising:
a plurality of climbing robots according to claim 55, the climbing robots including a first robot and a second robot;
a computing device; and
a wireless link coupled between the computing device and the first robot and configured to:
transmit control information from the computing device to the first robot; and
transmit sensor information or condition information from the first robot to the computing device;
wherein at least the second robot is directly coupled to the first robot by a wireless link.

67. A method of manufacturing a magnetic wheel, comprising:
providing a plurality of cylindrical permanent magnets;
forming a wheel block from a block material, the wheel block comprising a plurality of receptacles; and
fastening in each receptacle of the receptacles a respective permanent magnet situated flush with a circumferential surface of the wheel block;
wherein the receptacles are disposed in a plurality of rings about an axis of the wheel block, and the receptacles of two adjacent rings are azimuthally staggered.

68. The method of claim 67, wherein the block material comprises a compliant material.

69. The method of claim 67, wherein the receptacles are formed in a same additive or subtractive process as the rest of the wheel block.

70. The method of claim 67, further comprising coating at least part of the wheel block or magnets with an abrasive coating material.
